(19) United States
(12) Patent Application Publication
(10) Pub. No.: US 2008/0247442 A1
(43) Pub. Date: Oct. 9, 2008

(54) Method, Apparatus, and System for Modulating and Demodulating Signals Compatible with Multiple Receiver Types and Designed for Improved Receiver Performance

(76) Inventors: Philip V. Orlik, Cambridge, MA (US); Andreas F. Molisch, Arlington, MA (US); Shiwei Zhao, Pleasanton, CA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/995,996

(22) PCT Filed: Jul. 18, 2005
(86) PCT No.: PCT/US05/25271

§ 371 Date: Jan. 17, 2008

(51) Int. Cl. H04B 1/69

(52) U.S. Cl. 375/138; 375/E01.001

(57) ABSTRACT

A method, apparatus, and system for modulating and demodulating signals compatible with multiple receiver types and designed for improved receiver performance. The invention includes the use of hybrid impulse radio (H-IR) ultra-wideband (UWB) with forward error correction coding, recursive modulation and other techniques designed to enable one transmitter to transmit a waveform capable of being demodulated concurrently by a coherent receiver, a differentially coherent receiver, and/or a non-coherent receiver.

### CROSS REFERENCE TO RELATED APPLICATIONS

The present invention is related to application Ser. No. 10/964,918 (filed on Oct. 14, 2004) and application Ser. No. 11/074,168 (filed on Mar. 7, 2005), the entire contents of both being incorporated herein by reference.

### BACKGROUND OF THE INVENTION

1. Field of the Invention

A method, apparatus, and system for modulating and demodulating signals compatible with multiple receiver types and designed for improved receiver performance.

2. Discussion of the Background

In the United States, the Federal Communications Commission (FCC) allows a restricted unlicensed use of ultra-wide bandwidth (UWB) signals for wireless communication systems, “First Report and Order,” Feb. 14, 2002, the entire contents of which are incorporated herein by reference. The UWB signals must be in the frequency range from 3.1 to 10.6 GHz, and have a minimum bandwidth of 500 MHz. The FCC order also limits the power spectral density and peak emissions power of UWB signals, e.g. less than −43.1 dBm/MHz.

One modulation method for UWB uses extremely short time pulses to generate signals with bandwidths greater than 500 MHz, e.g., 1/1,000,000,000 of a second or less, which corresponds to a wavelength of about 300 mm. Systems that use short pulses are commonly referred to as impulse radio (IR) systems.

As shown in FIG. 1A, four different modulation techniques can be used for wireless communication systems, pulse position modulation (PPM) 11, pulse amplitude modulation (PAM) 12, on-off keying (OOK) 13, and bi-phase shift keying (BPSK) 14.

As an advantage, UWB systems can achieve high data rates, and are resistant to multi-path impairments due to the large processing gains. Additionally, the use of IR based UWB technology allows for the implementation of low cost, low duty cycle, low power transceivers that do not require local oscillators for heterodyning. Because UWB radios are primarily digital circuits, they can easily be integrated in a semiconductor chip. In UWB systems, multiple radios can concurrently share the same spectrum with no interference to one another, and are ideal for high-speed home and business networking devices, as well as sensor networks.

In a sensor network, it is desirable to enable the direct communication among multiple inexpensive sensing devices. The IEEE 802.15.4a standard defines a physical-layer for communications with scalable data rates from 1 Kbs to 1 Mbps, “IEEE P802.15.4a WPAN Alternate PHY-PAR,” 2003, for low power, low data rate network, the entire contents of which are incorporated herein by reference.

Generally, IR systems are either time-hopped (TH-IR) or direct-sequence (DS-IR), or transmitted-reference (TR-IR), or pulse position modulated (PPM). All systems use sequences of short duration pulses, p(t). However, the modulation and demodulation for these systems differ significantly, making them incompatible in the same network.

TH-IR system are described by M. Win and R. A. Scholtz, “Ultra-Wide Band Width Time-Hopping Spread-Spectrum Impulse Radio for Wireless Multiple-Access Communications,” in IEEE Trans. On Communications, Vol. 48, No. 4 April 2000, pp. 679-691, the entire contents of which is incorporated herein by reference. In a TH-IR system, each bit or symbol is represented by N_{f} pulses, where N_{f} is a positive integer. The time taken to transmit the bit is Tₛ. This is called the symbol duration. The time Tₛ is further partitioned into frames T_{f}, and the frames are partitioned into chips T_{c} corresponding typically to a pulse duration. If N_{c} represents the number of chips in a frame and N_{f} represents the number of frames in a symbol, then Tₛ, T_{f} and T_{c} are related as follows:

Tₛ=N_{f}T_{f}=N_{f}N_{c}T_{c}. (1)

FIG. 1B shows the relationship the symbol time Tₛ 101, the frame time T_{f} 102, and the chip time t_{c} 103 for pulses 104 for an example prior art TH-IR waveform 110 for a ‘0’ bit, and a waveform 120 for a ‘1’ bit. Typically, the pulses are spaced pseudo-randomly among the available chips in a frame according to a “time-hopping” code to minimize the effect of multi transmitter interference.

As stated above, the modulation can be binary phase shift keying. With BPSK, each bit b is represented as either a positive or negative one b ∈ {−1,1}. The transmitted signal has the form:

$$s ( t ) = {\sum }_{i = 1}^{∞} {\sum }_{j = 1}^{{N}_{f}} {h}_{i , j} {b}_{⌊ i / {N}_{f} ⌋} p ( t - {jT}_{f} - {c}_{j} {T}_{c} ) , \qquad ( 2 )$$

where cⱼ represents the j^{th} value of the TH code, in the range {0,1, . . . ,N_{c}−1}, and b is the i^{th} modulation symbol. Additionally, an optional sequence denoted as h_{i,j} can be applied to each pulse in the transmitted signal so as to shape the spectrum of the transmitted signal and to reduce spectral lines. The sequence, h_{i,j}, is called a polarity scrambling sequence with values of either +1 or −1. Different amplitudes are possible to give further degrees of freedom in the shaping of the spectrum.

A DS-IR system is very similar to TH-IR except that there is no time hopping, which means that cⱼ in Eq. (2) equals 0 and all pulses are aligned in the beginning of each frame. Now besides shaping the spectrum, the sequence hᵢⱼ becomes required and needs to be designed to offer good resistance to multi-access interference.

FIG. 2 shows a conventional coherent receiver 200 which works for both TH-IR and DS-IR signaling. The receiver includes an automatic gain control (AGC) unit 210 coupled to an amplifier 220 that is connected to the receive antenna 230. The receiver also includes synchronization 240, timing control 250, channel estimation 260, MMSE equalizer 270, and decoder 280 units. Rake receiver fingers 290 input to an adder 295. Each rake finger includes a pulse sequence generator, correlator and weight combiner. The rake fingers collect energy contained in the different multipath components, and also can reduce multipath interference. Due to the density of the multipaths in UWB signals, the number of required RAKE fingers can be large to obtain reasonable performance. The output of the adder is equalized and decoded. The typical TH-IR receiver has a significant complexity.

TR-IR systems eliminate the need for a RAKE receiver, R. Hoctor and H. Tomlinson, “Delay-Hopped Transmitted-Reference RF Communications,” IEEE Conference on Ultra Wide Band Width Systems and Technologies, 2002, pp. 265-269,”, the entire contents of which is incorporated herein by reference. In a TR-IR system, the information is encoded as phase differences of successive pulses in the sequence. Each symbol in a TR-IR system is a sequence of time-hopped ‘doublets’ or pairs of two consecutive pulses. Typically, the first pulse in the pair is referred to as a reference pulse and the second pulse is referred to as a data pulse. The two pulses in each pair are separated by a fixed unit of time T_{d}. Multiple pairs can be transmitted for one information bit. The transmitted waveform has the form:

$$s ( t ) = {\sum }_{i = 1}^{∞} {\sum }_{j = \frac{{iN}_{f}}{2}}^{( i + 1 ) \frac{{N}_{f}}{2} - 1} {h}_{i , j} ( p ( t - 2 {jT}_{f} - {c}_{j} {T}_{c} ) + {b}_{⌊ 2 j / Nf ⌋} p ( t - 2 {jT}_{f} - {c}_{j} {T}_{c} - {T}_{d} ) ) , \qquad ( 3 )$$

where T_{f}, T_{c}, h_{i,j} and N_{f} are the same as for the TH-IR case.

FIG. 3 shows the relationship the symbol time Tₛ 301, the frame time T_{f} 302, and the chip time T_{c} 303 for pulses 304 for an example TH-IR waveform 310 for a ‘0’ bit, and waveform 320 for a ‘1’ bit.

FIG. 4a shows a conventional TR-IR receiver 400, which is significantly simpler than the coherent receiver of FIG. 2. The receiver includes delay 401, multiplier 402, integrator 403, sampler 407 and decision 404 units. The receiver essentially correlates the received signal 405 with a delayed version 406. Obviously, the TR-IR 400 receiver is less complex than the coherent receiver 200. However, the reduced complexity is at the cost of requiring twice the number of pulses, and the additional energy required for the reference pulses, nominally 3 dB or more.

Another receiver type is a non-coherent energy detector which may be used along with OOK or PPM modulation. This receiver types has the advantage that it has the simplest hardware complexity though its performance might be the worst at most times.

It is clear that the decision to use either of the conventional TH/DS-IR or TR-IR or PPM modulation types leads to incompatible system structures. Therefore, as discovered by the inventors, it is desirable to provide a system structure that works with all (or at least several) of these transceivers, to enable cost, complexity and performance trade-offs within a common wireless network.

Application Ser. Nos. 10/964,918 and 11/074,168 describe systems and methods for incorporating different transceivers in the same wireless network. These applications also describe modulation formats that encode information bits in such a way to concurrently enable different receivers to demodulate the same signals. In addition, the modulation formats of applications Ser. Nos. 10/964,918 and 11/074,168 do not suffer from the inherent 3 dB loss of conventional (differentially decodable) modulation formats when the coherent receiver is used. The modulation formats of application Ser. Nos. 10/964,918 and 11/074,168 can be applied to narrow band, wide band, and ultra-wide band radio systems.

More specifically, the modulation formats of application Ser. No. 10/964,918 include a sequence of bits in a wireless communications network generated by a reference waveform, e.g., a pulse, and a data waveform, e.g., another pulse, of a waveform pair for each current bit. The phase of the reference waveform depends on a previously modulated bit, and a difference in phase (polarity) between the reference waveform and the data waveform pair depend on the current bit. This type of modulation is hereinafter defined as Hybrid-IR (H-IR).

In application Ser. No. 11/074,168, the H-IR scheme of application Ser. No. 10/964,918 was further generalized by including other modulation formats within a symbol. In one embodiment, the symbol period is partitioned into N time intervals, then the previously defined (H-IR) waveform is transmitted in a selected one of the N intervals. The selected interval can depend on the information bits that are to be modulated. This results in a higher order modulation that encodes bits in the position of the waveform similar to what is done in PPM, as taught by J. G. Proakis, “Digital Communications,” New York, N.Y.: McGraw-Hill, 4^{th} Ed., 2001, the entire contents of which are incorporated herein by reference. The major advantage of the modified H-IR scheme described in application Ser. No. 11/074,168 is that a PPM signal may be received using a non-coherent energy detector. That is, the additional division of the symbol duration into sub-intervals allows the transmitter to modulate bits via PPM as well as the H-IR technique described above. Now three types of receivers may be used to receive the same transmitted waveform: a receiver configured for non-coherent energy collection, a differentially coherent type receiver, as well as a coherent RAKE receiver. Of course the performance of these three types of receivers will vary with the more complex architectures achieving better overall BER performance.

In other words, application Ser. No. 11/074,168 describes a transmitter waveform that enables the type of system depicted in FIG. 4a. Here we show a simple system that includes of central node 410 and three other nodes 411, 412, 413. Nodes 411-413 differ only in the type of receiver that they use to demodulate the signal that is sent by node 410. For example node 411 contains a coherent receiver, node 412 contains a differential receiver, and node 413 contains a non coherent receiver. The invention described in application Ser. No. 11/074,168 enables all three node types to receive and demodulate node 410's transmissions concurrently (as long as they are within communication range of the transmitter).

The H-IR modulation of application Ser. Nos. 10/964,918 and 11/074,168, including or not including the addition of PPM modulation, has an additional advantage in that it adds memory to the transmitted waveform. As noted in of applications Ser. Nos. 10/964,918 and 11/074,168, this memory may be used to the advantage of coherent receivers by employing a Maximum Likelihood Sequence Detector (MSLD). Essentially, the H-IR modulation method as described in application Ser. Nos. 10/964,918 and 11/074,168 is a form of Trellis Coded Modulation (TCM). TCM has been shown to improve the performance of the coherent receiver relative to memoryless linear modulation techniques such as BPSK (see, for example, John B. Anderson and Arne Svensson “Coded Modulation Systems,” Kluwer Academic/Plenum Publishers, New York, N.Y., 2003, the entire contents of which is incorporated herein by reference.) Thus, as discovered by the inventors, it is desirable to apply various trellis coding/decoding techniques to achieve greater transceiver performance.

### SUMMARY OF THE INVENTION

The present invention provides a variety of new H-IR encoding/decoding devices, systems, methods and computer program products. These improvements include new H-IR modulation types coupled with convolutional codes with short constraint length. Additionally, the present invention combines various H-IR coding techniques with forward error correction (FEC) as a form of concatenated coding. Also, an improved H-IR technique is provided that includes iterative coding/decoding techniques for improved performance. One point of novelty is that the iterative decoding offers performance improvement comparable to a serially concatenated coding scheme without the additional complexity and data rate loss common in conventional systems by using only one additional level of code. Another embodiment is directed to a modified H-IR systems that uses Turbo codes.

Another embodiment of the present invention provides new modulation formats having improved performance by employing iterative coding/decoding. The H-IR codes described in application Ser. Nos. 10/964,918 and 11/074,168 may be viewed as a short convolutional code. Thus, these codes are non-recursive systematic codes. One embodiment of the present invention differs from the H-IR codes described in application Ser. Nos. 10/964,918 and 11/074,168 by virtue of the fact that the new H-IR codes are recursive codes, which is favored by iterative decoding methods, while the corresponding new modulation can still be demodulated by 2-3 different types of receivers.

One embodiment of the present invention is a transmitter that creates signals that embed (modulate) bit information in the absolute phase and the relative phase of pulse pairs called doublets. A sequence of doublets is then transmitted according to a time-hopping sequence and an optional polarity hopping sequence. (Both sequences are used for transmitter isolation and spectral smoothing of the transmitted signal). In one embodiment, information about the previous bit of an input bit sequence is used to determine the absolute phase of the reference pulse while the current bit is used to determine the relative phase (0°, 180°) of the reference pulse and the data pulse. This embodiment allows the concurrent reception/demodulation of the transmitted signal by both coherent and differentially coherent receivers. To enable non-coherent demodulation, the position of the doublets within a signal may also be modulated according to the information bits as well. In this embodiment, the current bit being transmitted determines the position of the doublets while the previous two bits determine the absolute phase of the reference pulse and the relative phase between the data and references pulse of the doublets.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, in which like reference numerals refer to identical or corresponding parts throughout the several views, and in which:

FIG. 1A is a timing diagram of prior art modulation techniques;

FIG. 1B is a timing diagram of prior art TH-IR modulation;

FIG. 2 is a block diagram of a prior art TH-IR receiver;

FIG. 3 is a timing diagram of prior art TR-IR modulation;

FIG. 4a is a block diagram of a prior art TR-IR receiver;

FIG. 4b is simplified network diagram showing three types of receivers within range of a single transmitter;

FIG. 5 is a block diagram of a hybrid-IR transmitter according to a first embodiment of the invention;

FIG. 6 is a trellis diagram used by a differentially coherent receiver according to the first embodiment of the invention;

FIG. 7 is a block diagram of a hybrid-IR coherent receiver according to the first embodiment of the invention;

FIG. 8 is a diagram of hybrid-IR modulation according to the first embodiment of the invention;

FIG. 9 is a two-state trellis diagram used by a differentially coherent receiver according to a second embodiment of the invention;

FIG. 10 is a four-state trellis diagram used by a coherent receiver according to the second embodiment of the invention;

FIG. 11 is a block diagram of a hybrid-IR transmitter according to the second embodiment of the invention;

FIG. 12 is block diagram of a hybrid-IR differentially coherent transmitter according to the second embodiment of the invention;

FIG. 12a is a block diagram of a non-coherent receiver according to the second embodiment of the invention;

FIG. 13a is a block diagram of a sequential encoding transmitter according to a third embodiment of the invention;

FIG. 13b is a more detailed block diagram of a sequential encoding transmitter according to the third embodiment of the invention;

FIG. 14 is a block diagram of a sequential decoding receiver according to the third embodiment of the invention;

FIG. 14a is block diagram of a coherent receiver according the third embodiment of the invention;

FIG. 14b is a block diagram of a differentially coherent receiver according to the third embodiment of the invention;

FIG. 15 is a block diagram of a recursive encoding transmitter according to a fourth embodiment of the invention;

FIG. 15a is block diagram of a sequential recursive receiver according to the fourth embodiment of the invention;

FIG. 15b is a block diagram of a sequential recursive differentially coherent receiver according to the fourth embodiment of the invention;

FIG. 16 is a two-state trellis diagram used by a sequential recursive differentially coherent receiver according to the fourth embodiment of the invention;

FIG. 17 is a block diagram of recursive encoding transmitter according to a fifth embodiment of the invention;

FIG. 17a is a block diagram of sequential recursive receiver according to the fifth embodiment of the invention;

FIG. 17b is a block diagram of sequential recursive non-coherent receiver according to the fifth embodiment of the invention;

FIG. 18 is a four-state trellis diagram used by a sequential recursive coherent receiver according to the fifth embodiment of the invention;

FIG. 18a is a two-state trellis diagram used by a sequential recursive differentially coherent receiver according to the fifth embodiment of the invention;

FIG. 19 is a diagram of how symbol based detection is conducted on the two state trellis shown in FIG. 16 according to a sixth embodiment of the invention;

FIG. 20 is a block diagram of a sequential recursive encoding transmitter according to a seventh embodiment of the invention;

FIG. 21 is a two-state trellis diagram used by a sequential recursive differentially coherent receiver according to the seventh embodiment of the invention; and

FIG. 22 is a block diagram of a parallel concatenated encoder according to an eighth embodiment of the invention.

FIG. 22a is a block diagram of transmitter incorporating the parallel concatenated encoder of FIG. 22.

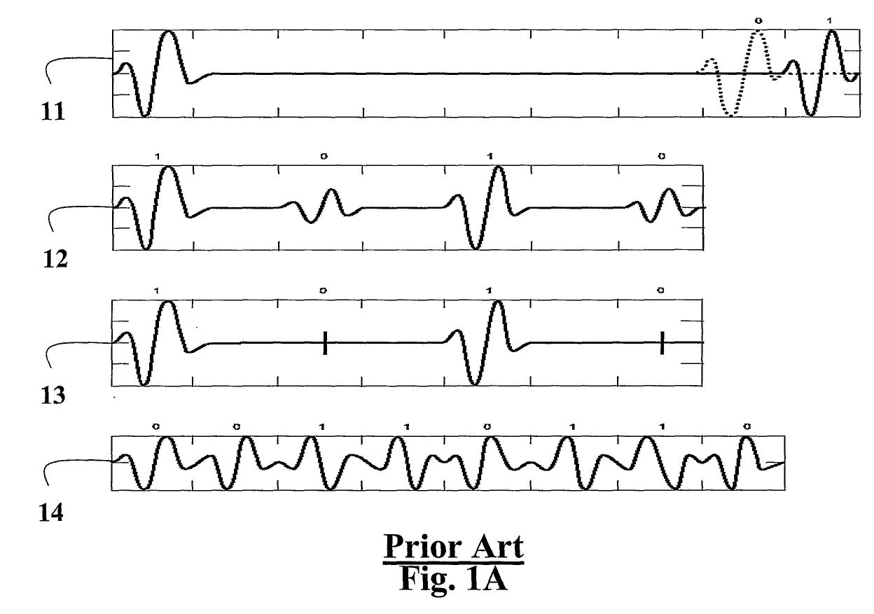

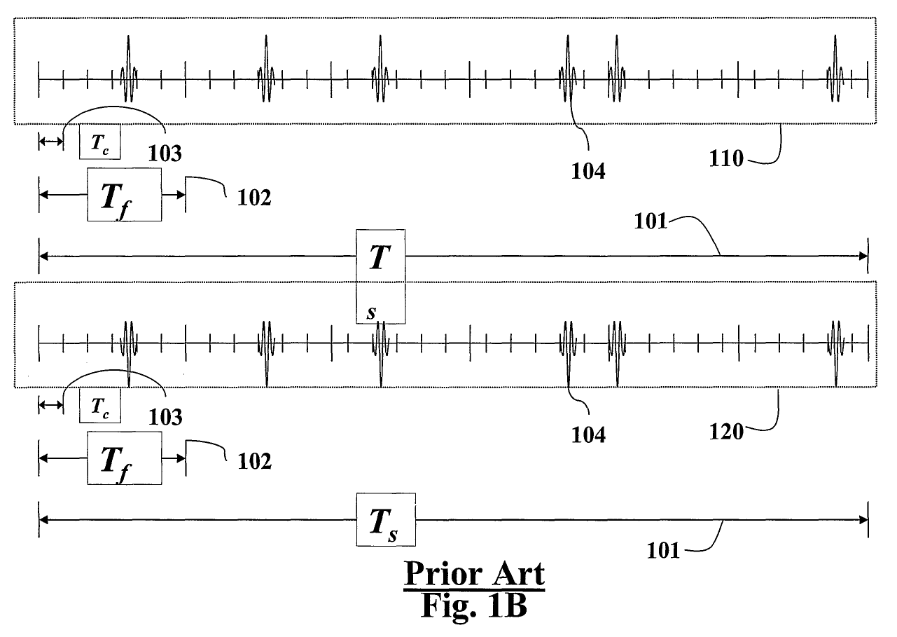

### DETAILED DESCRIPTION OF THE PREFERRED EMBODIMENT

As noted previously, the present invention includes extensions to the inventions described in described in application Ser. Nos. 10/964,918 and 11/074,168 in which a variety of Hybrid-IR (H-IR) systems were introduced. The H-IR systems described in application Ser. Nos. 10/964,918 and 11/074,168 enabled TH-IR, TR-IR, and non-coherent receivers to co-exist in the same wireless network. That is, the previously described H-IR systems enabled TH-IR, TR-IR, and non-coherent receivers to be concurrently serviced by a common modulated waveform. Advantageously, the previously described H-IR systems provided a modulation format with memory. Modulation formats that have memory can be represented by a trellis diagram by which a modulation that encodes information bits in both the pulse (or symbol) position and the pulse amplitude can be understood.

### First Embodiment

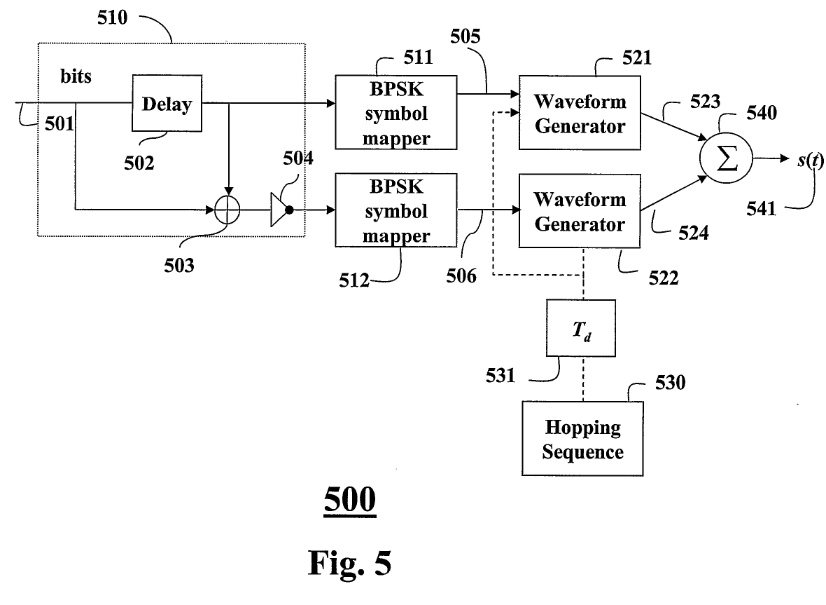

By way of review, FIG. 5 shows a H-IR transmitter 500 according to a first embodiment of the invention, and as first described in application Ser. No. 10/964,918. The transmitter includes a pre-processor 510 for input bits 501. The pre-processor includes a delay 502 and an adder 503. The pre-processor may also be viewed as a simple form of a convolutional coder, and in the case of 510 it is a coder with constraint length 2. The adder sums each input bit 501 to a delayed version of the bit, the sum is inverted 504. It should be noted here that the encoder, 510, can be any systematic encoder not just the constraint length 2 encoder shown. More importantly and for use in the subsequent discussion the encoder may be a recursive systematic convolutional encoder. The pre-processing generates a pair of modulating bits from two successive information bits. It should be noted that more than one pair of modulation bits can be used for each information bit. During each symbol period, the symbols are modulated 511-512. Reference waveforms, e.g., pulses 523, in the sequence are BPSK modulated 511 according to the input bits 501, and data waveforms, e.g., pulses 524, are BSPK modulated 512 according to the inverted sum. Waveform generators 521-522 which emit a sequence of pulses are controlled by the outputs of the BPSK modulators 511-512, which set the phases of the emitted pulses 521-522 and according to a hopping sequence 530 and delay T_{d} 531, which set the timing of the individual pulse emissions. The results are combined 540.

The transmitted signal, s(t) 541, can be expressed as

$$s ( t ) = {\sum }_{i = 1}^{∞} {\sum }_{j = \frac{{iN}_{f}}{2}}^{( i + 1 ) \frac{{N}_{f}}{2} - 1} {b}_{⌊ 2 j / {N}_{f} ⌋ - 1} p ( t - 2 {jT}_{f} - {c}_{j} {T}_{c} ) + ( \overline{{b}_{⌊ sj / {N}_{f} ⌋ - 1} ⊕ {b}_{⌊ 2 j / {N}_{f} ⌋}} ) p ( t - 2 {jT}_{f} - {c}_{j} {T}_{c} - {T}_{d} ) . \qquad ( 1 )$$

The modulation according to equation (1) shows that a phase difference between the reference pulse and data pulse is identical to a conventional TR-IR system. Table A shows the four possible combinations of a previous and a current bit, the corresponding values of the reference and data waveforms, and their phase differences or polarities.

TABLE A

| | | | | Phase difference |
|---|---|---|---|---|
| | | Reference pulse | Data pulse | between reference |
| | | modulation | modulation symbol | pulse and |
| Previous bit | Current bit | symbol b_{└2j/N}_{_{f}}_{┘-1} | b_{└2j/N}_{_{f}}_{┘-1} ⊕ b_{└2j/N}_{_{f}}_{┘} | modulated pulse |
| 0 | 0 | −1 | 1 | 180° |
| 0 | 1 | −1 | −1 | 0° |
| 1 | 0 | 1 | −1 | 180° |
| 1 | 1 | 1 | 1 | 0° |

If the current bit is 0, then the phase difference between the reference pulse and the data pulse is always 180° regardless of the value of the previous bit. If the current bit is 1, then the phase difference is 0°.

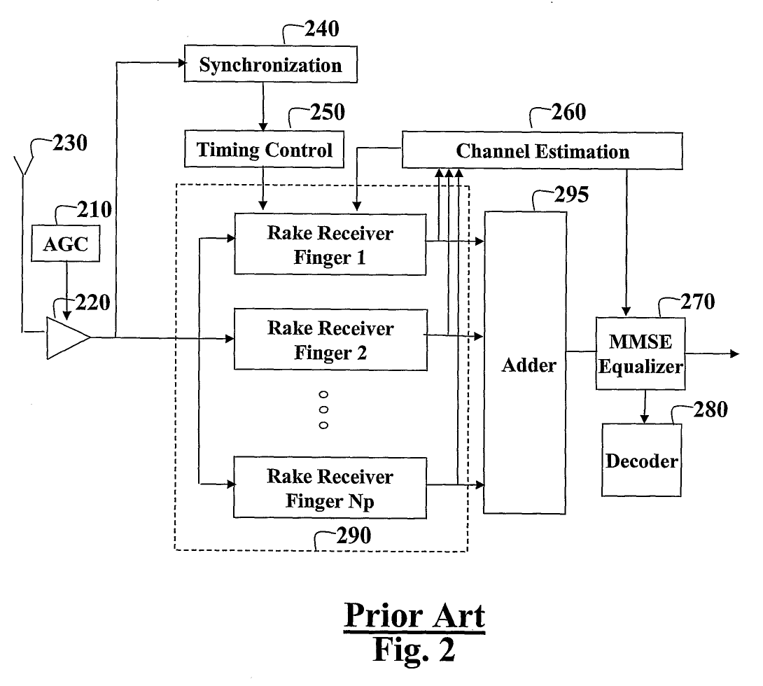

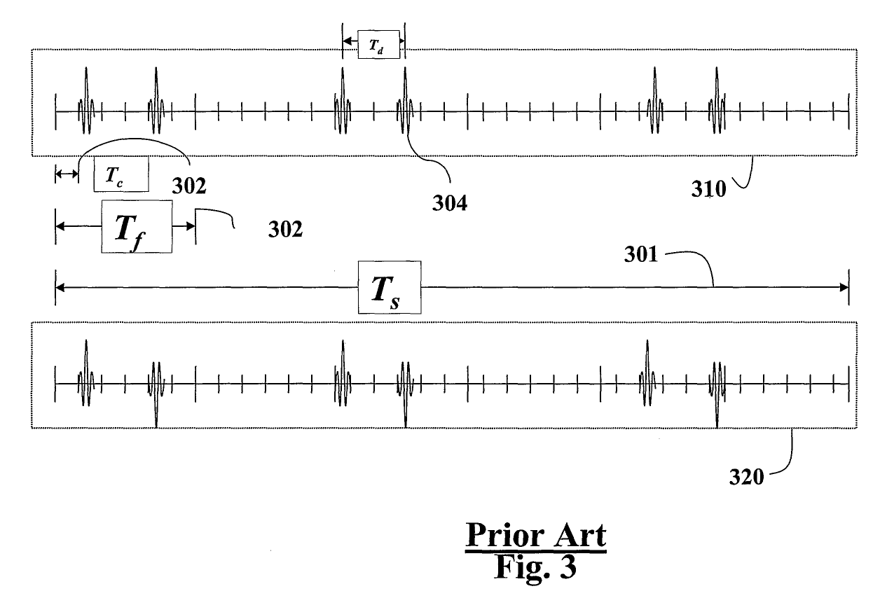

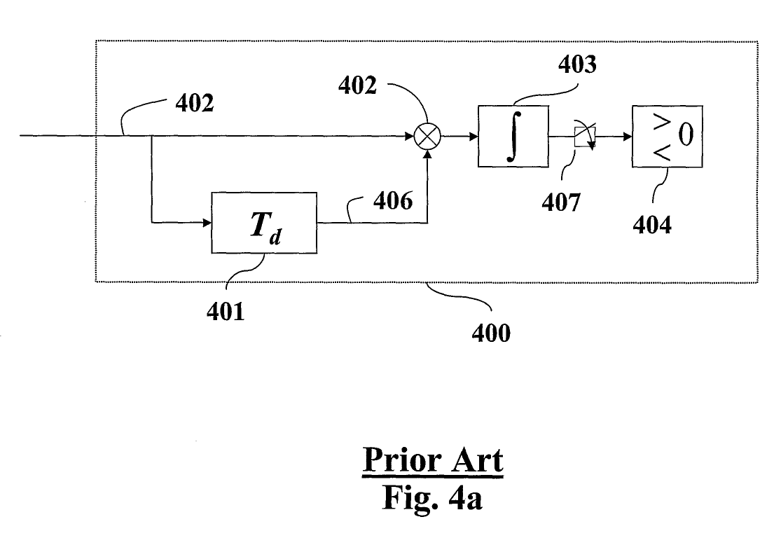

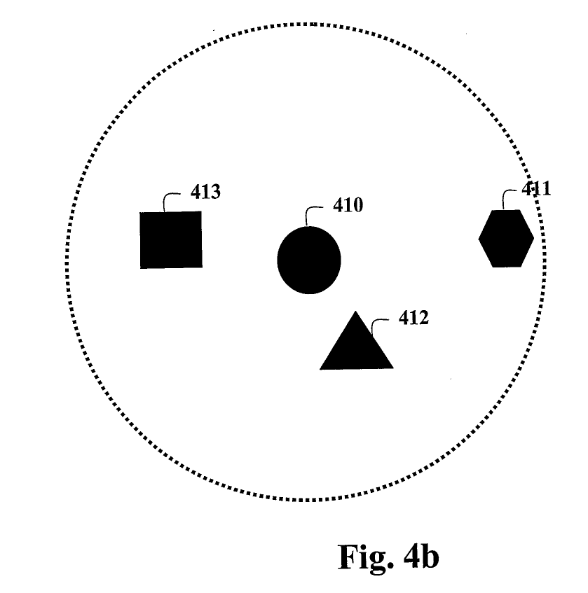

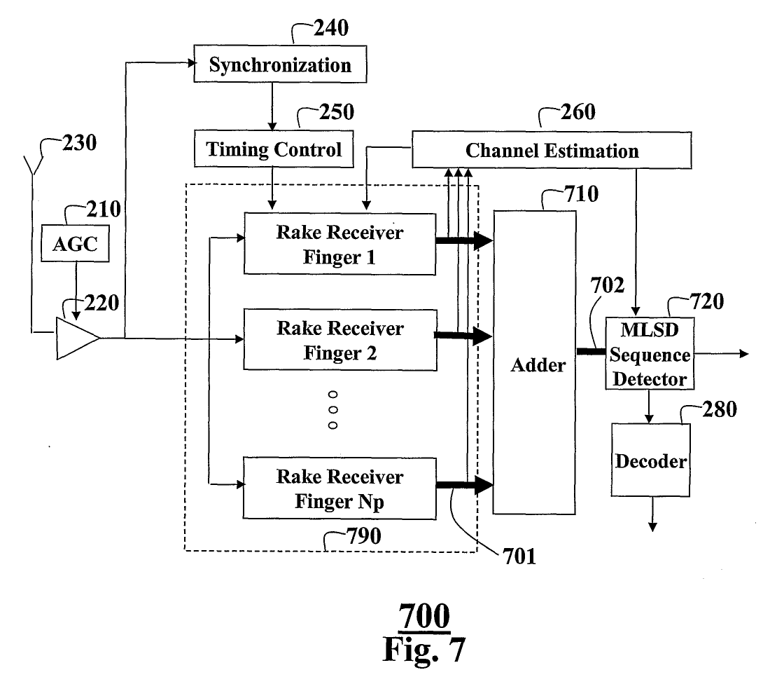

It should be clear that a conventional TR-IR receiver can demodulate the signal according to the invention. That is, the conventional differentially coherent receiver of FIG. 4a can be used to detect the phase difference between reference and data pulse and thus can demodulate the data. These transmitted signal cannot be demodulated by the conventional coherent RAKE receiver shown in FIG. 2. However, the transmitted signal can be concurrently demodulated by the coherent TH-IR receiver shown in FIG. 7.

The receiver shown in FIG. 7 has improved performance relative to the conventional coherent TR-IR receiver shown in FIG. 4a. The gain in performance is based on the fact that information is encoded in both the reference pulses and the data pulses. Thus, the coherent TH-IR receiver shown in FIG. 7 can use the energy in the reference pulses to make decisions on the values of the transmitted bits, see Table A. During each symbol period, a sequence of N_{f}/2 pairs is transmitted. The pair in each frame is described as a sequence of pulses, each with a polarity of the pulses depending on the current and previous bit that are transmitted. There are four possible combinations of pairs.

$$\begin{matrix}{s}_{0} ( t ) = - 1 * \frac{1}{\sqrt{{N}_{f} {E}_{p}}} p ( t ) + 1 * \frac{1}{\sqrt{{N}_{f} {E}_{p}}} p ( t - {T}_{d} ) \\ {s}_{1} ( t ) = - 1 * \frac{1}{\sqrt{{N}_{f} {E}_{p}}} p ( t ) - 1 * \frac{1}{\sqrt{{N}_{f} {E}_{p}}} p ( t - {T}_{d} ) \\ {s}_{2} ( t ) = 1 * \frac{1}{\sqrt{{N}_{f} {E}_{p}}} p ( t ) - 1 * \frac{1}{\sqrt{{N}_{f} {E}_{p}}} p ( t - {T}_{d} ) \\ {s}_{3} ( t ) = 1 * \frac{1}{\sqrt{{N}_{f} {E}_{p}}} p ( t ) + 1 * \frac{1}{\sqrt{{N}_{f} {E}_{p}}} p ( t - {T}_{d} )\end{matrix} \qquad ( 2 )$$

The coefficient

$$\frac{1}{\sqrt{{N}_{f} {E}_{p}}}$$

in the above equations normalizes the transmitted symbol to unit energy, where Eₚ is the energy of the pulse, and N_{f} is the number of pulses in a symbol. Note that this set of four signals can be described with two orthogonal basis functions Ψ₀ and Ψ₁. If we select

$${ψ}_{0} ( t ) = \frac{1}{\sqrt{{N}_{f} {E}_{p}}} p ( t ) and {ψ}_{1} ( t ) = \frac{1}{\sqrt{{N}_{f} {E}_{p}}} p ( t - {T}_{d} ) \qquad ( 3 )$$

as the basis functions, then, we can express the four possible pairs as

s₀(t)=−1*ψ₀(t)+1*ψ₁(t),

s₁(t)=−1*ψ₀(t)−1*ψ₁(t),

s₂(t)=1*ψ₀(t)−1*ψ₁(t), and

s₃(t)=1*ψ₀(t)+1*ψ₁(t). (4)

We can also represent the signals as a vector

s₀=[−1 1]

s₁=[−1 −1]

s₂=[1 −1]

s₃=[1 1] (5)

Therefore, the transmitted signal can be described as follows. During each symbol period, the transmitter transmits a sequence of N_{f}/2 pairs. The four possible pairs are given by equation (4). The pairs are optionally time hopped and scrambled with a polarity code to enable multiple transmitters on a single channel and for spectral smoothing of the transmitted waveform.

As shown in equation 5, the transmitted signal is a multi-dimensional signal because we can use multiple basis signals to represent the transmitted signal. By accommodating the multi-dimensional description of the symbol waveform and the memory between consecutive symbols, a coherent TH-IR receiver can achieve additional coding gain by using a MLSD detector. Methods that approximate the MSLD detector, such as Viterbi decoding can also be used.

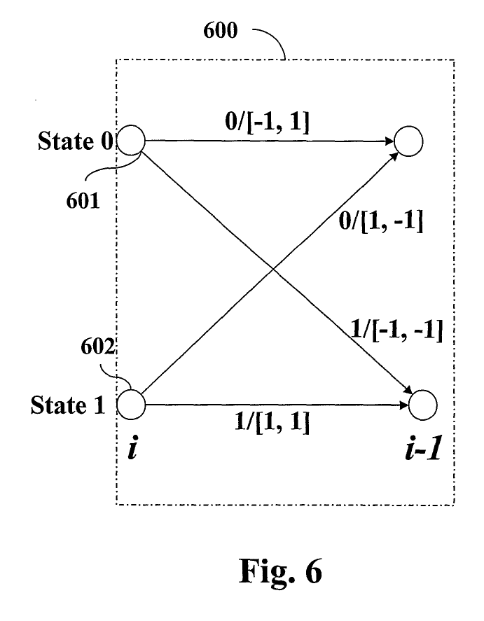

FIG. 6 shows a diagram 600 for a coherent decoder (e.g., Viterbi decoder) using a trellis. The trellis has two states, where a state 0 601 is a value of a previous 0 bit, and state 1 602 is a value of a previous 1 bit. Branches of the trellis indicate possible transitions. The branches are labeled with the value of current bit, and the vector representation of the transmitted pair. For example, if the current state is 0 and a ‘1’ bit is to be transmitted, then a transition to state 1 occurs, and pair s₁=[−1 −1] is transmitted. The differentially coherent TR receiver does not require a MLSD in this case. The current bit is encoded in the phase difference. The reason for the MSLD in the coherent case is that the coherent receiver can determine the absolute phases of the pulses and the encoder of 510 is adjusting the phase of the reference bit according the value of the previous bit.

With this interpretation of the hybrid-IR modulation, we see that a coherent TH-IR receiver can be used to demodulate the signal. The TH-IR receiver is adapted to accommodate the two-dimensional description of the symbol waveform and the relationship between consecutive symbols according to the invention.

FIG. 7 shows a coherent TH-IR receiver 700 according to the first embodiment of the invention. As before, the receiver includes a RAKE structure 790. However, now the RAKE fingers correlate the incoming signal with sequences of the two basis pulses, ψ₀(t) and ψ₁(t). The output of each RAKE finger is now a 2-D vector 701. The outputs of the finger are summed 710 to produce soft input observations 702 for a conventional maximum likelihood sequence detector (MLSD) 720. The MLSD detector determines a most probable path through the trellis 600 for a given sequence of observations 702. Methods that approximate the MSLD detector, such as Viterbi decoding can also be used.

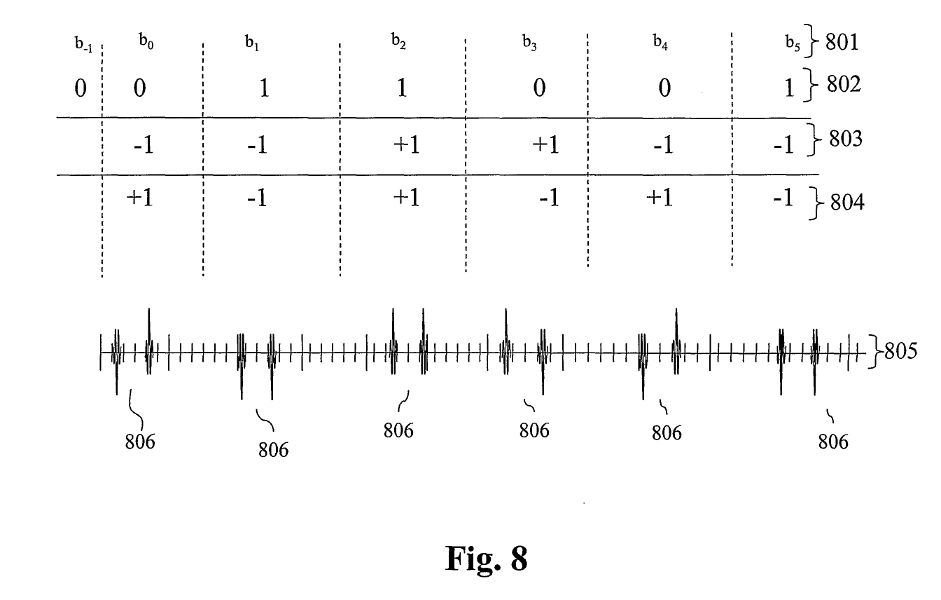

FIG. 8 shows the relationship between symbols, bits and modulated waveforms. The six symbols of the sequence 801 to be modulated are labeled b₀ to b₅, with a previous encoded symbol ‘0’. The symbols in the example sequence are
{0, 1, 1, 0, 0, 1} 802,
   which correspond to reference bits
{−1, −1, +1, +1, −1, −1} 803,
   and data bits
{+1, −1, +1, −1, +1, −1} 804,
   and a waveform 805 with reference and data pulse pairs 806, where a “down” pulse encodes ‘−1’ and an ‘up’ pulse encodes ‘+1’.

From FIG. 8, we see that the waveform 805 has the properties described earlier. Specifically, the phase difference between the reference pulse and the data pulse in each pair 806 contains the information about the current bit being transmitted. For each pair the phase difference is 180° when a ‘0’ bit is transmitted, and the phase difference is 0° when a ‘1’ bit is transmitted.

Additionally, the sequence of pairs also contains the information about the previous bit in the polarity of the reference pulse. Again, this is seen in FIG. 8, where the reference pulse in each pair has a ± polarity that indicates the value of the previously encoded bit. That is, a positive polarity is sent when the previous bit was a ‘1’, and a negative polarity is sent when the previous bit was a ‘0’. It should be understood, that the polarities can all be reversed to achieve the same result.

Therefore, this waveform enables the use of both coherent and differentially coherent receivers, as depicted in FIGS. 4 and 7 respectively, in the same network. The choice of receiver can be based on considerations such as required performance, cost of implementation, or desired transmission distance. Generalization, to the case when multiple pairs are used to transmit a symbol, is straightforward. In this case each pair is repeated a number of times, and a polarity scrambling code can be used to improve the spectral characteristics of the waveform.

### Second Embodiment

In application Ser. No. 11/074,168, we generalized the H-IR scheme described in application Ser. No. 10/964,918 by including other modulation formats within a symbol. For example, we described partitioning the symbol period for the current bit into N time intervals, so that can transmit the previously defined waveforms in a selected one of the N intervals. The selected interval can depend on the information bits that is are to be modulated. In this way, we described a higher order modulation that encodes bits in the position of the waveform as is done in PPM.

The major advantage of this scheme is that a PPM signal may be received using a non-coherent energy detector. The additional partitioning division of the symbol period duration into multiple sub-intervals allows the transmitter to modulate bits via PPM as well as the H-IR technique described above. Now a receiver may be used that is based on energy collection or a differentially coherent type receiver, as well as a coherent RAKE receiver. Of course the performance of these receivers will vary with the more complex architectures achieving better overall bit error rate (BER) performance. The addition of PPM modulation also increases the ‘memory’ of the modulation format. In this case, the trellis used to decode the signal, as seen by the differentially coherent receivers and coherent receivers, is modified as is described below.

In one example of the second embodiment, we consider the simplest case with the addition of binary PPM (BPPM). In this case, the symbol interval is partitioned into two intervals: a first half (F); and a second half (S). The current bit of the bit stream is used to select between one of two possible positions. That is, a bit ‘1’ is encoded in the first interval and a bit ‘0’ is encoded in the second interval.

Additionally, we assume that the waveform that is transmitted is constructed as described for the H-IR scheme above. Because the current bit is being used to modulate the position of the waveform in this case, the two immediate previous bits are used to modulate the reference pulse and data pulse that constitute the doublets of the symbol waveform. Thus, a simple non-coherent receiver can decode the selected transmission interval, i.e., the pulse position. Moreover, we can still use a differentially coherent or coherent RAKE receiver and the higher level trellis encoding/decoding can improve performance.

Further generalizations are possible. We can extend the doublet to a waveform that contains multiple pulses, i.e., two or more pulses. In this manner, a higher order TR scheme can be developed where one of the pulses in the waveform acts as a reference for other pulses Thus, we can achieve a higher order modulation that transmits multiple bits in a single symbol period, i.e., N-ary modulation formats maybe considered within this framework. In this case, the transmitted waveform conveys several bits rather then a single bit. The method introduces memory among consecutive symbols with ‘memory’. Thus, a differentially coherent or coherent receiver can make use of this memory feature by implementing trellis demodulation on the sequence of received symbols.

It is noted that further mapping of previous bits can be employed to modulate the polarity of the reference pulse, and maintain the proper phase relation with the data pulse. Additionally, it is noted that this scheme can be further generalized by the addition of PPM modulation on the multi-pulse waveform.

Next, we describe the embodiment of the coherent receiver that enables reception of the extended H-IR modulation. Again, we are considering the use of a BPPM as described above.

Because BPPM uses the waveform positions to carry information bits, we obtain longer ‘memory’ length in each frame when we use a differentially coherent or coherent RAKE receiver. In this case, the length of the memory is two bits, i.e., the immediate previous encoded bits before the current bit bᵢ. That is, bits bᵢ₋₂ and bᵢ₋₁ are used to modulate polarity of the reference pulse according to the H-IR scheme above and the bit bᵢ₋₁ determines the phase difference and the polarity of the reference pulse, while the current bit bᵢ determines the waveform position within the symbol duration. Then, trellis modulation can be performed as described below.

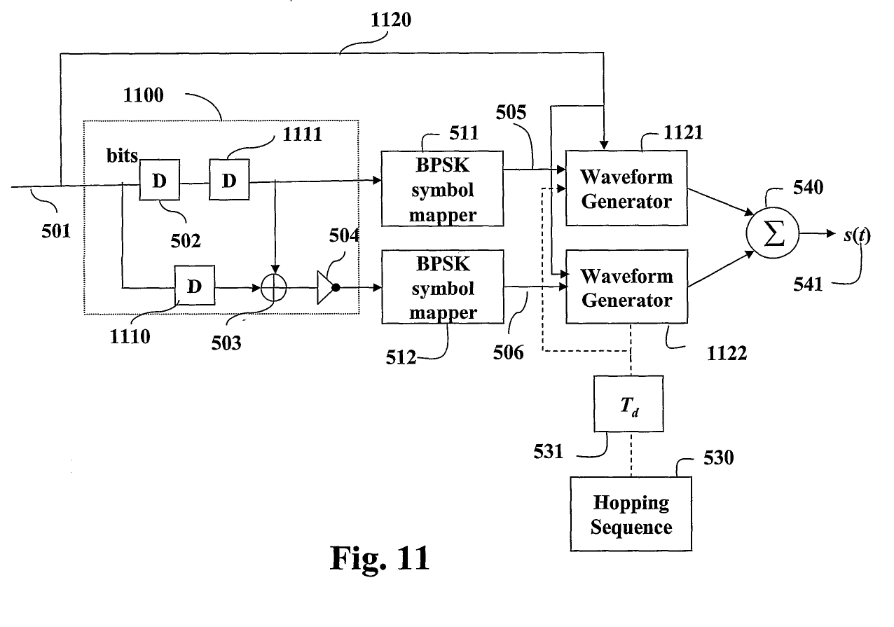

FIG. 11 shows changes made to the H-IR transmitter 500 of FIG. 5. Pre-processor 1100 corresponds to pre-processor 510, albeit modified to embody the additional modulation format. Now the two input bits 501 to the adder are the two previous bits because of the addition of two delay units 1110 and 1111. Then, the sum of the two previous bits is inverted 504. The current bit 501 now is encoded by another modulation format (e.g., BPPM) provided on a bypass line 1120 to achieve higher orders. The selections and configuration of encoded bits can be generalized to many different options.

Table B shows eight possible combinations of a current bit and two previous bits, the corresponding values of the reference and data waveforms, and their phase differences or polarities.

TABLE B

| | | | | | Phase difference | |
|---|---|---|---|---|---|---|
| | | | Reference | | between | Doublet |
| | | | pulse | Data pulse | reference | position |
| | | | modulation | modulation | pulse and | (F: first half, |
| | | | symbol | symbol | modulated | S: second |
| i − 2 | i − 1 | i | b_{2j/N}_{_{f}}_{┘-1} | b̅_̅{̅̅2̅j̅/̅N̅}̅_̅{̅_̅{̅f̅}̅}̅_̅{̅┘̅-̅1̅}̅ ⊕̅ b̅_̅{̅̅2̅j̅/̅N̅}̅_̅{̅_̅{̅f̅}̅}̅_̅{̅┘̅}̅ | pulse | half) |
| 0 | 0 | 0 | −1 | 1 | 180° | F |
| 0 | 1 | 0 | −1 | −1 | 0° | F |
| 1 | 0 | 0 | 1 | −1 | 180° | F |
| 1 | 1 | 0 | 1 | 1 | 0° | F |
| 0 | 0 | 1 | −1 | 1 | 180° | S |
| 0 | 1 | 1 | −1 | −1 | 0° | S |
| 1 | 0 | 1 | 1 | −1 | 180° | S |
| 1 | 1 | 1 | 1 | 1 | 0° | S |

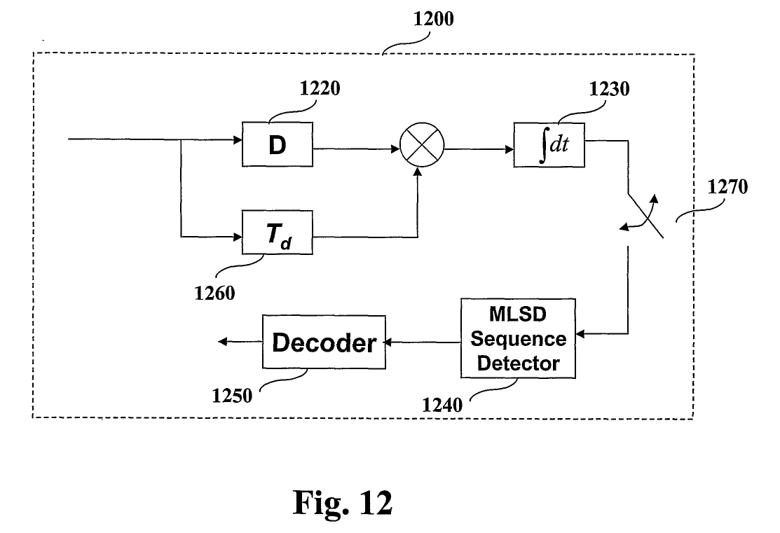

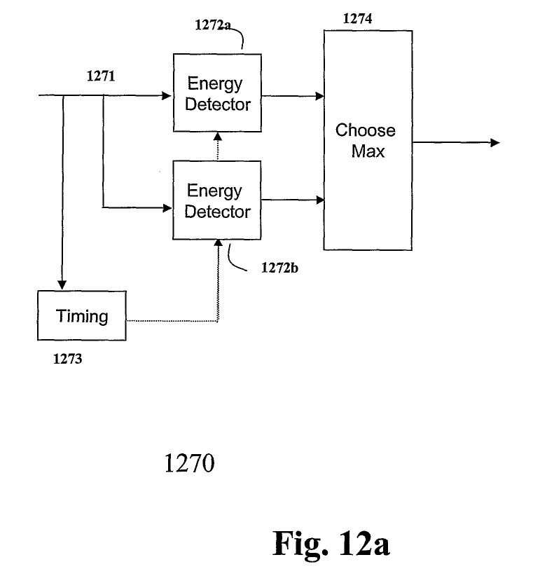

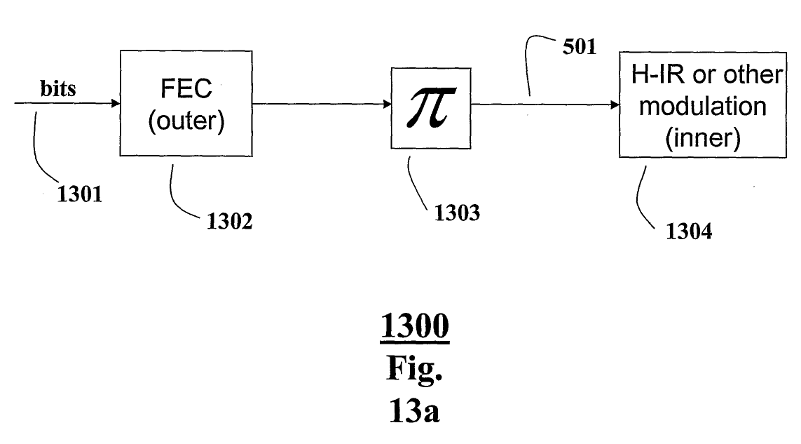

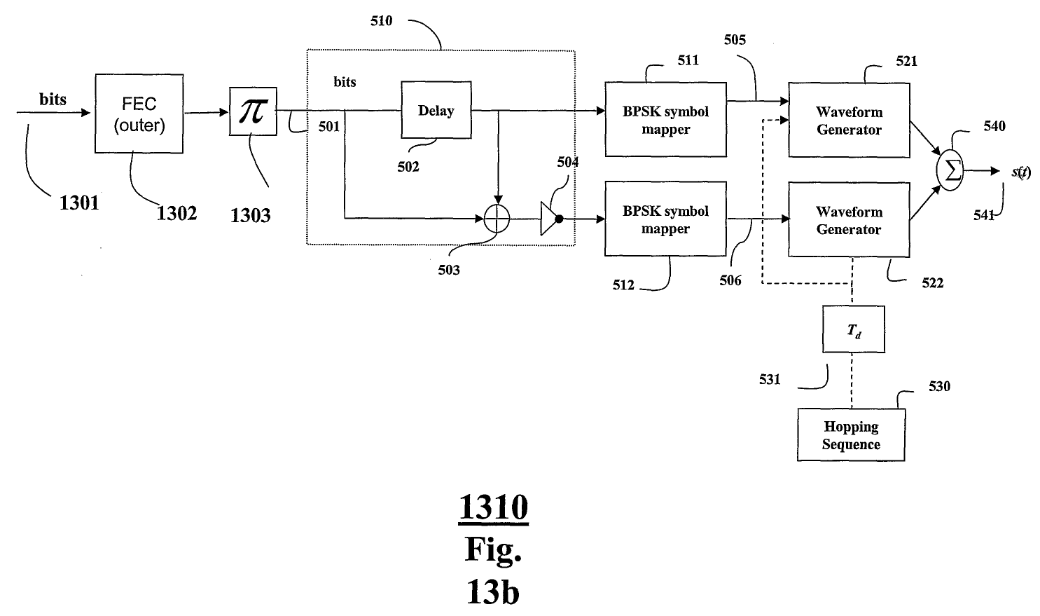

The signal can be demodulated using a non-coherent BPPM receiver that selects the time interval (first half or second half) with the largest receiver energy. FIG. 12a is a block diagram of a non-coherent detector 1270 used in the second embodiment of the invention. The non-coherent detector consists of a timing circuit 1273 and energy detectors 1272a and 1272b. The energy detectors simply compute the total energy of the received signal in the first half and second half of a symbol interval and then feed these energies to a decision device 1274. The decision device chooses the maximum energy and decides that the current bit is ‘1’ if the energy in the first half of the symbol is larger; it decides ‘0’ otherwise. This detector does not infer the fine structure of the waveform and, therefore, does not achieve coding gains of more complex receiver structures.

The signal can also be demodulated by a differentially coherent TR or coherent RAKE receiver with improved performance. The gain in performance is based on the fact that information of previous bits, i.e., memory, is encoded in both the reference pulse and the data pulse of the current bit. The additional information can help the TR or RAKE receiver to make decisions on the values of the transmitted bits, see Table A.

As an example of this approach for differentially coherent TR demodulation, we note that the waveform position (first half or second half) represents the current received bit, and phase difference between the reference and data pulses represents the previously received bit.

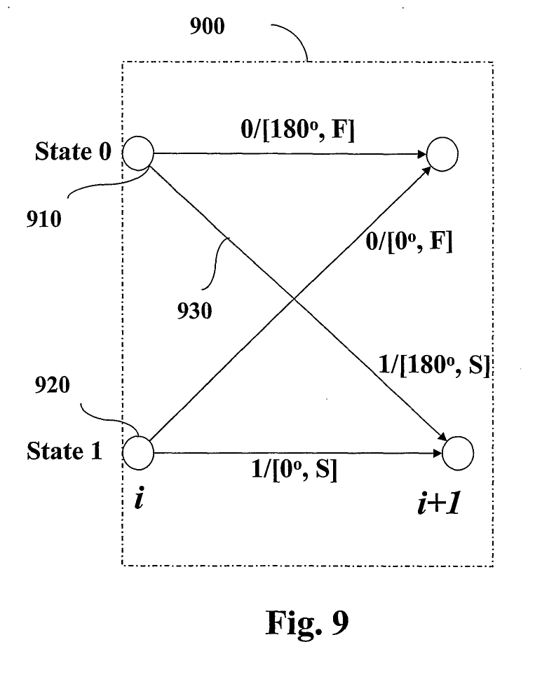

FIG. 9 shows a two-state trellis 900 that can be used for the differentially coherent decoding. Here, a state ‘0’ 910 maps to a previous bit ‘0’, and a state ‘1’ 920 maps to a previous bit ‘1’. Branches 930 of the trellis indicate possible state transitions. The branches are labeled with the value of current bit, and a vector representation of the transmitted pair, where the previous bit is demodulated by the phase difference between reference and data pulses, and the current bit is demodulated by the waveform position, and F and S represent first half and second half, respectively.

FIG. 12 shows a differentially coherent TR receiver 1200 according to the second embodiment of the invention. After pre-filtering the received signal with a matched filter (MF) (not shown) matched to the transmitted waveform, the receiver correlates the received signal 1260 with a delayed version 1220. The correlated result is integrated in integrator 1230 and passed to a selector 1270. However, different from the prior art, the decision is not made after integration 1230 and select 1270. Instead, a MLSD detector 1240 takes as input the output of the correlator at the two possible waveform positions and the relative phase difference between pulses from inputs, and determines a most probable path through the trellis 900 based. The output of the detector is provided to a decoder 1250. Methods that approximate the MSLD detector, such as Viterbi decoder, can also be used.

For coherent RAKE demodulation, we have three information sources in each symbol: reference waveform, data waveform, and doublet position. Correspondingly, we can use the position to demodulate the current bit and use the pulse polarity combination, as described above, to demodulate the previous two bits.

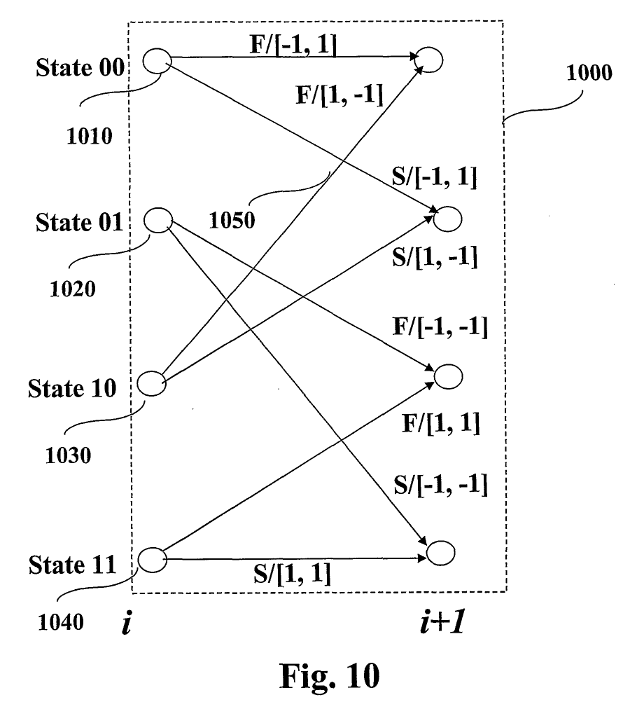

FIG. 10 shows a four-state trellis for a coherent RAKE receiver according to the invention. This trellis is used by the MLSD sequence detector 720 in the coherent receiver shown in FIG. 7.

Here, a state ‘00’ 1010 maps to previous bits 00, a state ‘01’ 1020 maps to previous bits ‘01’, a state ‘10’ 1030 maps to previous bits ‘10’, and a state ‘11’ 1040 maps to previous bits ‘11’. Branches 1050 of the trellis indicate possible transitions. The branches are labeled with the waveform position of current bit, and the vector representation of the transmitted pulse pair. The trellis demodulation can be incorporated into the MLSD detector 720 of the RAKE receiver 700 of FIG. 7. The MLSD detector 720 determines a most probable path through the trellis 1000 for a given sequence of observations. Methods that approximate the MSLD detector, such as Viterbi decoder, can also be used.

### Third Embodiment

In practical communication systems, forward error correction (FEC) encoding can be used before the signal modulation to enhance the system reliability. Reliability can be further improved with a serial or parallel concatenation of two, or even more, FEC codes. Iterative decoding can be used to further improve the overall error correction capability. However, the use of serial or parallel concatenation reduces bit rates and increases hardware complexity.

However, it is possible to implement a powerful iterative decoding method with only one, rather than two, additional FEC encoders. That is, because the modulation formats described in application Ser. Nos. 10/964,918 already has ‘memory’ and can be considered to be a trellis encoding. The H-IR modulations described in Application Ser. Nos. 10/964,918 and 11/074,168 can be viewed as an inner encoder. By adding an FEC encoder as an outer encoder, powerful iterative encoding and decoding can be employed at the transmitter and receivers with much reduced cost and complexity as compared to conventional sequential FEC encoding techniques. That is, because only one FEC encoder is required, the addition of hardware cost is limited and there is no data rate reduction by inner encoding. It is also worth to noting that the inner encoder is not limited to be the Hybrid-IR modulation schemes described in application Ser. Nos. 10/964,918, but can be any trellis coded modulation (TCM) scheme which encodes different information as ‘memory’.

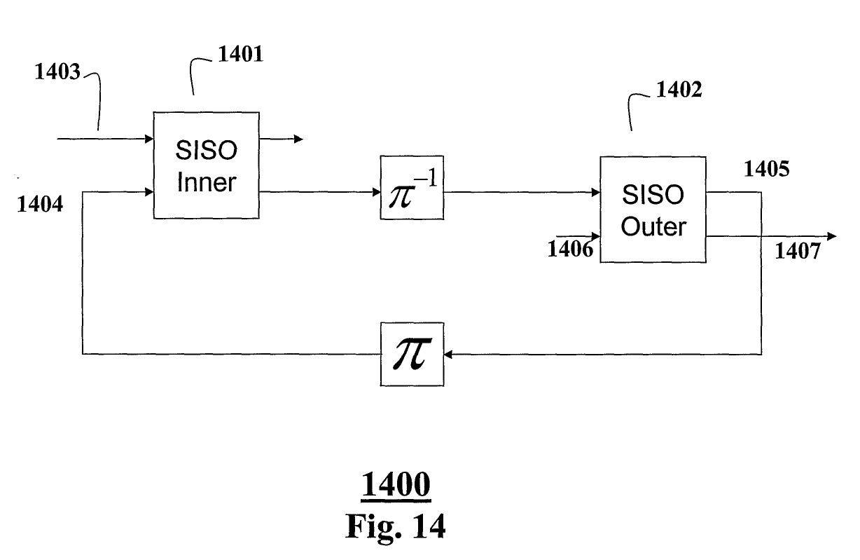

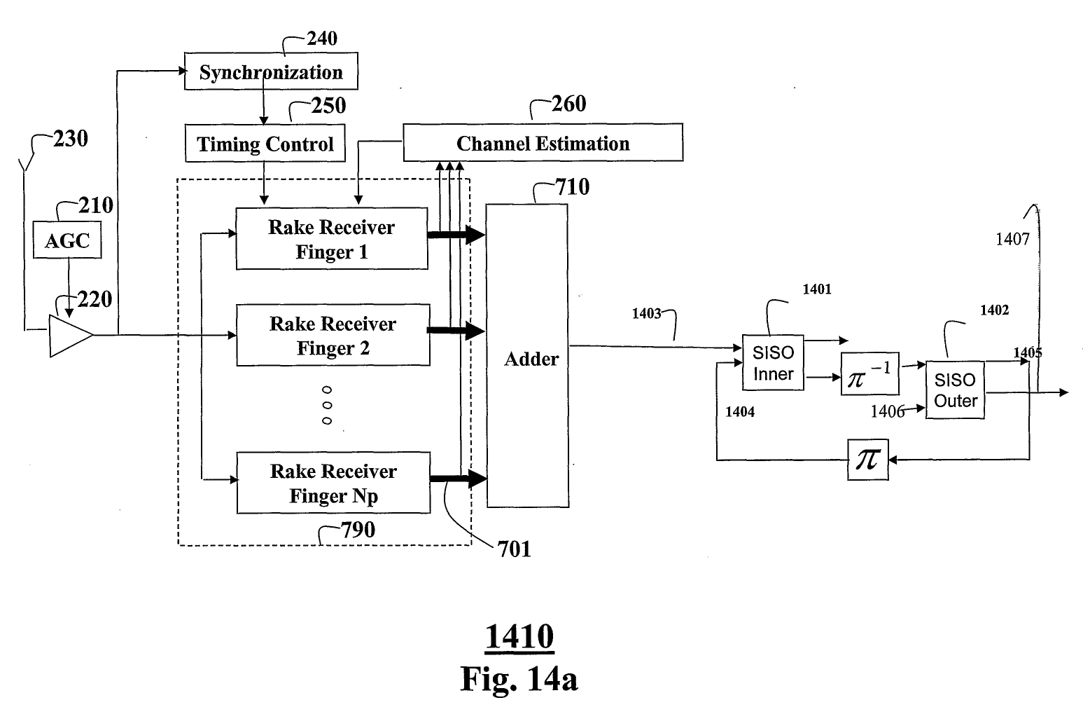

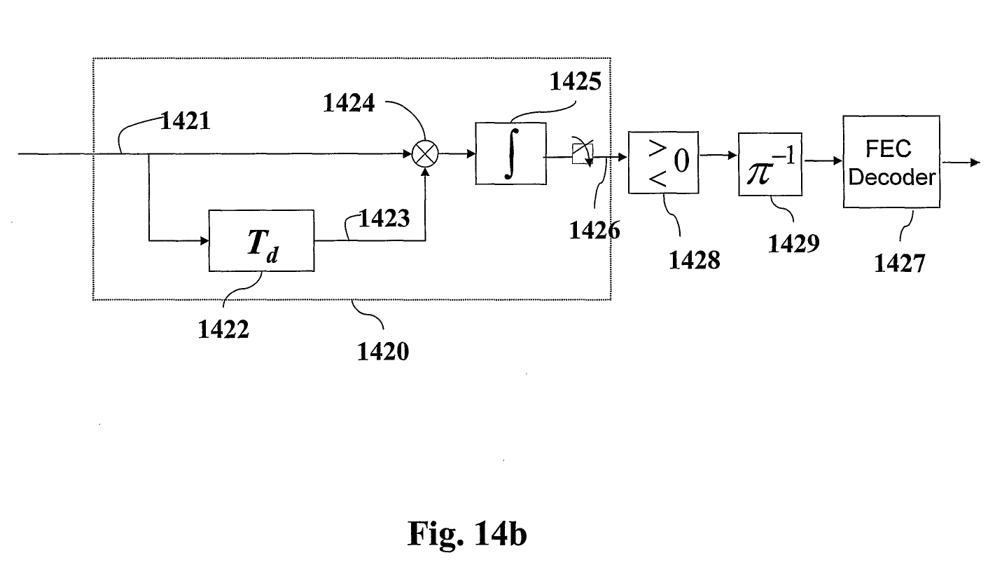

FIG. 13a and FIG. 14 are block diagrams of an iterative encoder and iterative decoder according to the third embodiment of the present invention. In FIG. 13, before the signal modulation 1304, which can be H-IR modulation, 500, as in FIG. 5 or any other coded modulation, the information bits 1301 are FEC encoded 1302 and passed through an interleaver 1303, e.g., a pseudo-random interleaver, to reduce burst errors in the decoding stage.

FIG. 13b explicitly shows that modifications to FIG. 5 used for this implementation. The bits are input to an outer FEC coder 1302. While the FEC code used in the outer FEC coder 1302 may be any form of FEC (block code, linear block code or convolutional code), it is preferable to use a convolutional code for improved BER performance. The output of the outer FEC is then interleaved 1303, and passed to outer FEC coder 1302. The use of the interleaver is optional and provides for improved burst noise performance. The processing afterwards is identical to that of FIG. 5.

To implement iterative decoding in the receiver, we replace the MLSD detector 720 shown in FIG. 7 with decoder 1400 shown in FIG. 14. The iterative decoder 1400 includes the cascade of an inner decoder 1401 and an outer decoder 1402. Both decoders 1401 and 1402 are SISO (soft-input soft-output) decoders. A SISO decoder is a four-port device, which accepts as inputs reliability information, or a corresponding probability distributions of the information and coded symbols and outputs an update of the reliability information based on the code constraints. In another example, it is possible to replace SISO 1401 and 1402 with corresponding hard decoders, however, BER performance is likely to be reduced.

The upper output of the inner SISO decoder 1401 is not used in the iterative decoding procedure and the lower input 1406 of the outer SISO decoder 1402 is typically set to zero for the decoding of binary codes. The rest of the decoding procedure follows an iterative decoding process of serially concatenated codes selected for use.

FIG. 14a shows the coherent receiver according to the third embodiment of the invention and is intended for use with the transmitter depicted in FIG. 13b. In FIG. 14a, the MLSD detector 720 and decoder 280 of FIG. 7 has been replaced with the iterative decoding scheme of FIG. 13a. Thus, the output of the rake combiner is fed directly to the input 1403 of the iterative decoder.

The inner SISO decoder 1401 may be a MAP or ML demodulator configured to demodulate a predefined trellis modulation, e.g., the trellis 600 shown in FIG. 6. Use of such a MAP or ML demodulator incurs little extra complexity in an overall receiver design. The soft input of coded symbol 1403 is from the RAKE combiner 710, and the soft input of information symbol 1404 is the re-interleaved feedback 1404 from the outer SISO decoder 1402. The lower output 1407 of the outer SISO decoder 1402 is the most recent estimate of the information bit. One example process for use in the demodulator 1401 is the modified BCJR algorithm described in S. Benedetto, D. Divsalar, G. Montorsi, and F. Pollara, “Serial Concatenation of Interleaved Codes: Performance Analysis, Design, and Iterative Decoding,” IEEE Trans. On Info. Theory, vol. 44, no. 3, May 1998, incorporated herein by reference. Other BCJR and non-BCJR algorithms may be used instead.

It is noted that the addition of the FEC and interleaver in FIG. 13b does not affect the property of H-IR modulation that enables concurrent reception by coherent and differentially coherent receivers. With the transmitter of FIG. 13b, the phase difference between the reference pulse and the data pulse still carry information. However, it is no longer the input bit sequence directly, but the coded sequence after encoding 1302 and interleaving 1303 that carries this information.

The differentially coherent demodulator corresponding to the transmitter shown in FIG. 13b is depicted in FIG. 14b. The inner coder/demodulator 1420 delays the input signal/reference pulses 1421 with delay 1422. The delayed signal 1423 is correlated with the reference pulses 1421 in correlator 1424. Integrator 1425 integrates the correlated results. The soft values 1426 resulting from the correlation are then sent to the FEC decoder 1427 via bit decision device 1428 and deinterleaver 1427.

The bit decision device 1428 and the decoder 1427 represented in FIG. 14b is a “soft decoder.” An even simpler receiver can be obtained by reversing the order of the bit decision device 1428 and the FEC decoder 1427 so that the decoder 1427 works on a hard decision from the output 1426 of the integrator 1425, rather than on soft decisions from the bit decision device 1428. This has the advantage of easier implementation of the decoder but with reduced BER performance relative to a soft decision decoder.

The outer FEC code 1302 can optimize operations with the inner trellis modulation. That is, one skilled in the art recognizes that one convolutional or block code works better with a particular inner modulation scheme, while another convolution or block code works better with a different inner modulation scheme.

The preceding description was based on inserting the transmitter of FIG. 5 into the inner modulator 1304 of FIG. 13a, as well as substituting the MLSD detector 720 and decoder 280 of FIG. 7 with the iterative decoding scheme of FIG. 13a. In another example not shown, it is possible to insert the transmitter of FIG. 11 into the inner modulator 1304 of FIG. 13a, as described in U.S. application Ser. No. 11/074,168. The corresponding coherent receiver is the receiver of FIG. 14a, with the inner SISO configured to operate on 4-state trellis 1000 in FIG. 10. The corresponding differentially coherent receiver is the receiver of FIG. 14b configured to operate on the 2-state trellis 900 shown in FIG. 9. The corresponding non-coherent receiver is the receiver of FIG. 12a.

### Fourth Embodiment

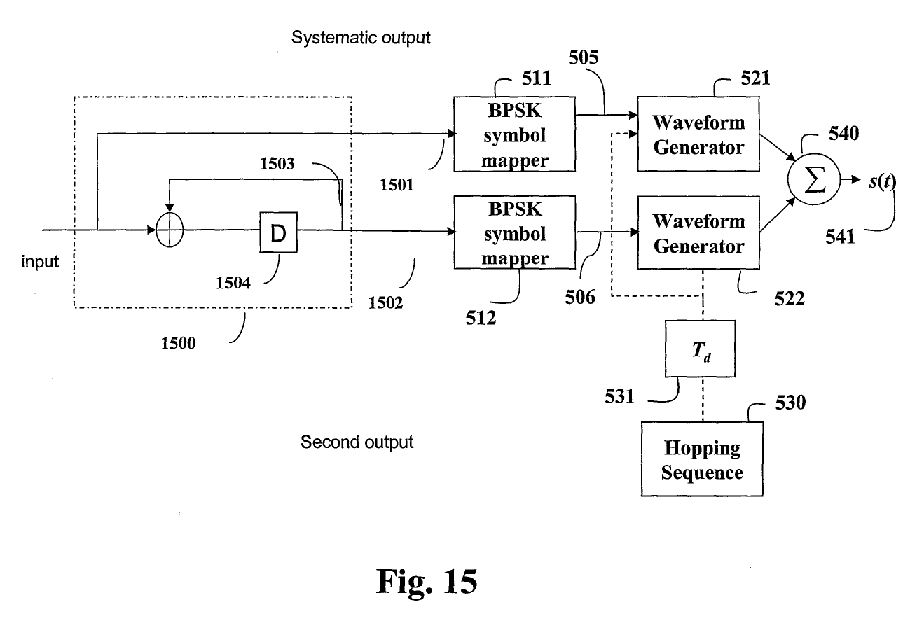

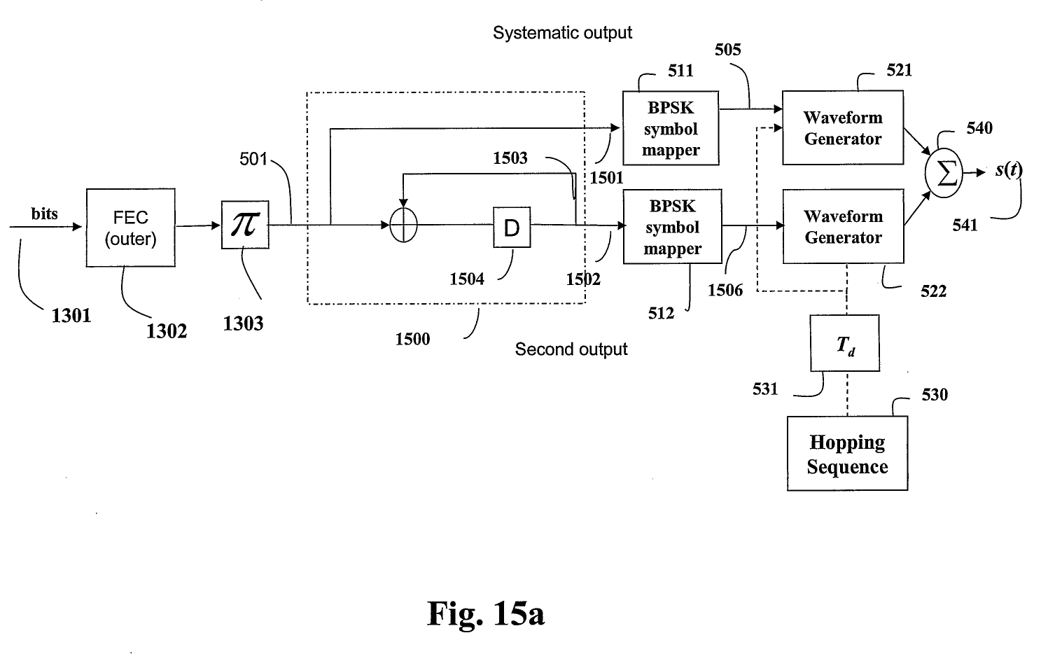

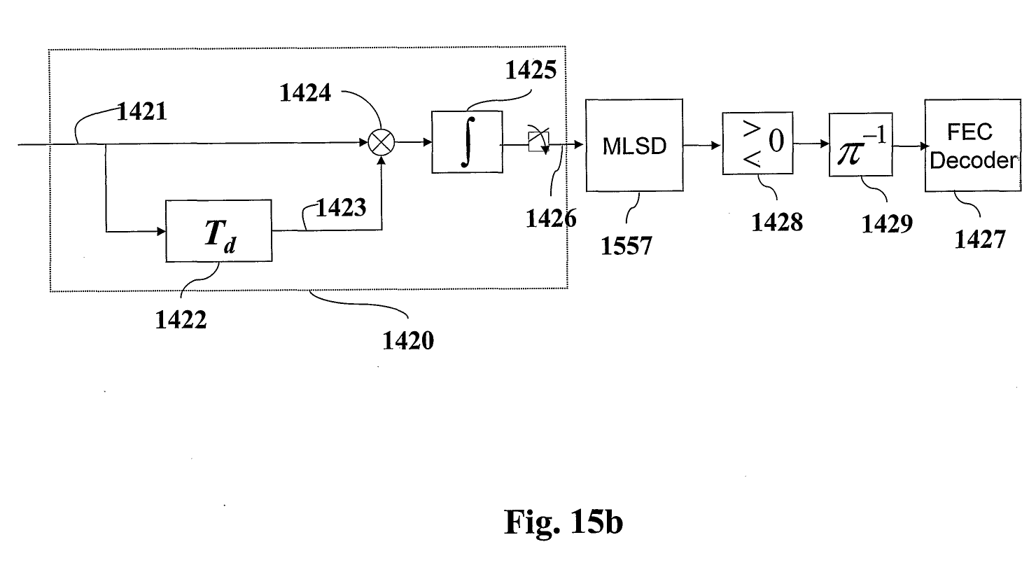

Using concatenated coding along with iterative decoding, the use of Recursive Systematic Codes (RSC) for the constituent coders can improve the bit error rate performance. Upon review of the output of the H-IR modulator 1304 and its associated trellis (600, 900, or 1000), one can recognize this as a systematic convolutional encoding. That is, the current bit/symbol is always present in the polarity of the reference signal. The fourth embodiment of the present invention introduces a modification to the any of the first, second or third embodiments that takes advantage of the properties of RSC codes as they apply to concatenated coding. This can be achieved by changing the processing unit 510 of FIGS. 5 or 13a, or pre-processing unit 1100 of FIG. 11, with processing unit 1500 shown in FIG. 15.

With FIG. 15 representing just one example, the only change relative to FIG. 5 is the replacement of the previously described delay circuit 510 with a feedback circuit 1500 including a delay line 1503 feeding back from the output of the delay element 1504. The undelayed signal 1501 is input to BPSK symbol mapper 511 and the delayed signal 1502 is input into BPSK symbol mapper 512. This replacement of components transforms the systematic convolutional coding depicted in trellis 600 of FIG. 6, to an RSC coding of the input bit sequence.

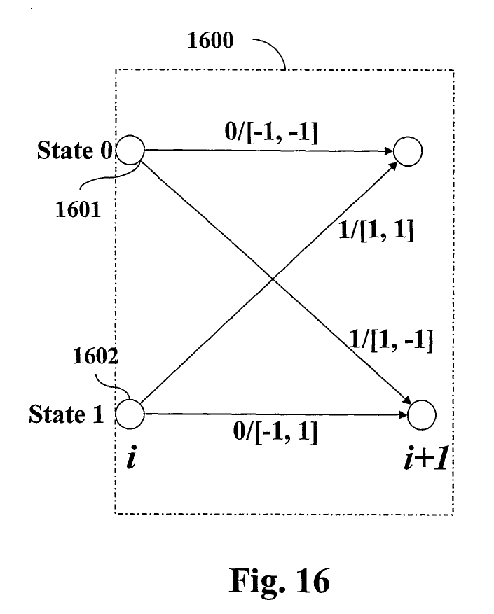

For example, processing unit 510 in FIG. 5 is the trellis encoder generating trellis 600 shown in FIG. 6. In the present embodiment, processing unit 1500 in FIG. 15 may be viewed as a new ½ rate convolution encoder described by the polynomial

$$[ 1 , \frac{D}{1 + D} ] ,$$

where the denominator 1+D represents the feedback line, 1503. Trellis 1600 shown in FIG. 16 is the trellis corresponding to RSC encoder 1500 shown in FIG. 15.

By way of further example, the transmitter shown in FIG. 15a corresponds to the transmitter of FIG. 13b with processing block 510 of FIG. 13b replaced with the recursive systematic block 1500. In this example, one may precede the recursive H-IR modulation with an outer FEC and (optional) interleaver. The two output bits are used to encode the reference and data pulse described in application Ser. No. 10/964,918. Thus, the coherent receiver shown in FIG. 14a can decode as before. The only modification to the coherent receiver of FIG. 14a is that the inner SISO decoder 1401 uses a slightly different trellis structure than that of the original sequence detector of FIGS. 5 and 6. That is, the inner SISO decoder 1401 uses the trellis structure 1600 shown in FIG. 16.

Trellis 1600 is a two state trellis, where the output labels on each of the trellis branches now reflect the RSC encoding of encoder 1500 shown in FIG. 15a. This example provides the additional BER performance benefits that comes with using a RSC code in concatenated coding and iterative decoding. Again, the choice of receiver can be based on considerations such as required performance, cost of implementation, or desired transmission distance. Table C shows four possible combinations of the trellis state and the input bit, and the corresponding pulse pair polarities.

TABLE C

| | | | | Phase difference |
|---|---|---|---|---|
| | | | | between reference |
| Trellis | Current | | | pulse and |
| state | bit | Reference pulse | Data pulse | modulated pulse |
| 0 | 0 | −1 | −1 | 0° |
| 0 | 1 | 1 | −1 | 180° |
| 1 | 0 | −1 | 1 | 180° |
| 1 | 1 | 1 | 1 | 0° |

In addition to the coherent receiver in FIG. 14a (modified to recognize trellis 1600), a differentially coherent receiver can also demodulate a signal transmitted by the transmitter of FIG. 15a. We first note that the phase differences in Table C no longer represent the current bit that is being transmitted, so the simplest differentially coherent TR receiver shown in FIG. 4a is no longer applicable. However, the value of the phase difference between the reference and data pulses now depends on the state of the coder 1500 in FIG. 15 or 15a. For example, when the trellis state is ‘0’ a current bit of ‘1’ induces a 180 degree phase difference between the pulses. While a current bit of ‘0’ does not induce a phase change. The situation is reversed when the state of the trellis is ‘1’. Using this information, the signal transmitted by the transmitter of FIG. 15 or 15a can be demodulated with a differential coherent receiver that performs an MLSD to recover the bits 501 that entered the H-IR modulator. If the transmitter of FIG. 15a is used, then the bits 501 are sequence coded, so that the detected coded bits are decoded via a de-interleaver 1559 and FEC decoder 1560.

At this point one may ask why not use the iterative scheme depicted in FIG. 14b? While this is possible, the difficulty with this approach is that the extrinsic information required by the SISO decoders is not readily available from the simple phase detector 1420, and thus, it is simpler to use the receiver shown in FIG. 15b. Here, the output 1426 of the integrator 1425 is fed to a MLSD 1557. MLSD 1557 outputs a signal to the serial circuit of bit decision device 1428, deinterleaver 1429 and FEC decoder 1427. MLSD 1557 operates on the trellis 1600 shown in FIG. 16.

As shown in FIG. 15, in an alternative example of this embodiment, one can use a recursive encoding transmitter without the FEC coder and/or without the interleaver. The receivers described above is modified to remove modules for FEC decoding and/or deinterleaving. While a simpler configuration, this transmitter and receivers associated with this option is less reliable.

In summary, with the device of FIG. 15, a sequence of doublets is transmitted according to a time-hopping sequence and, optionally, a polarity hopping sequence. Both sequences are used for transmitter isolation and spectral smoothing of the transmitted signal. Information about the previous bit of an input bit sequence is used to determine the absolute phase of the reference pulse while the current bit is used to determine the relative phase (0°, 180°) of the reference pulse and the data pulse. This allows the concurrent reception/demodulation of the transmitted signal by both coherent and differentially coherent receivers.

### Fifth Embodiment

In some situations it is desired to allow concurrent coherent, TR, and non-coherent demodulation. As noted previously, U.S. application Ser. No. 11/074,168 described an extended H-IR modulation that enables concurrent coherent, differentially coherent (TR), and non-coherent demodulation without causing the coherent receiver to incur a performance loss. That technique combined pulse position modulation (PPM) as well at the differential encoding of the pulses.

In another example of the fourth embodiment, preprocessor 1100 shown in FIG. 11 is replaced with recursive circuit 1500 shown in FIG. 15.

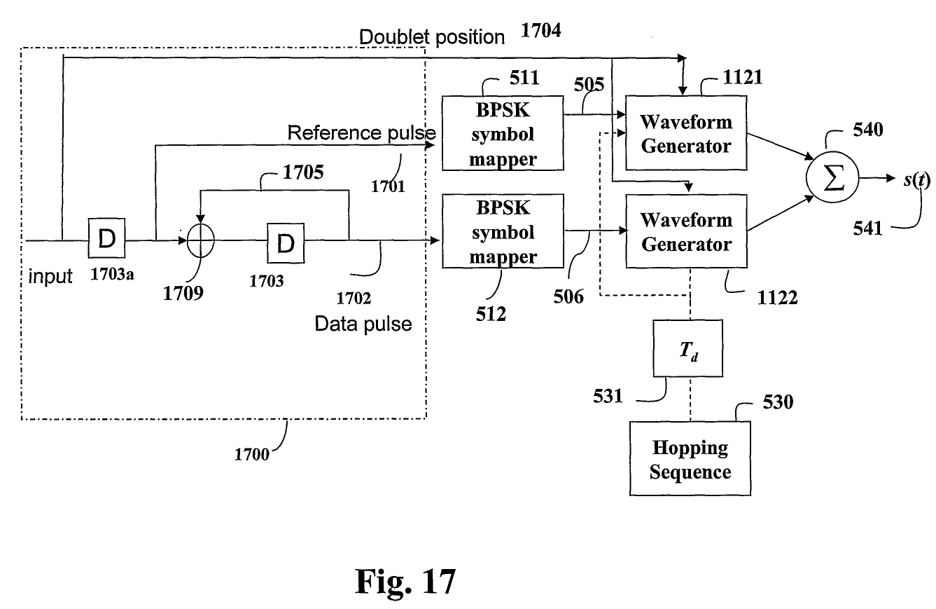

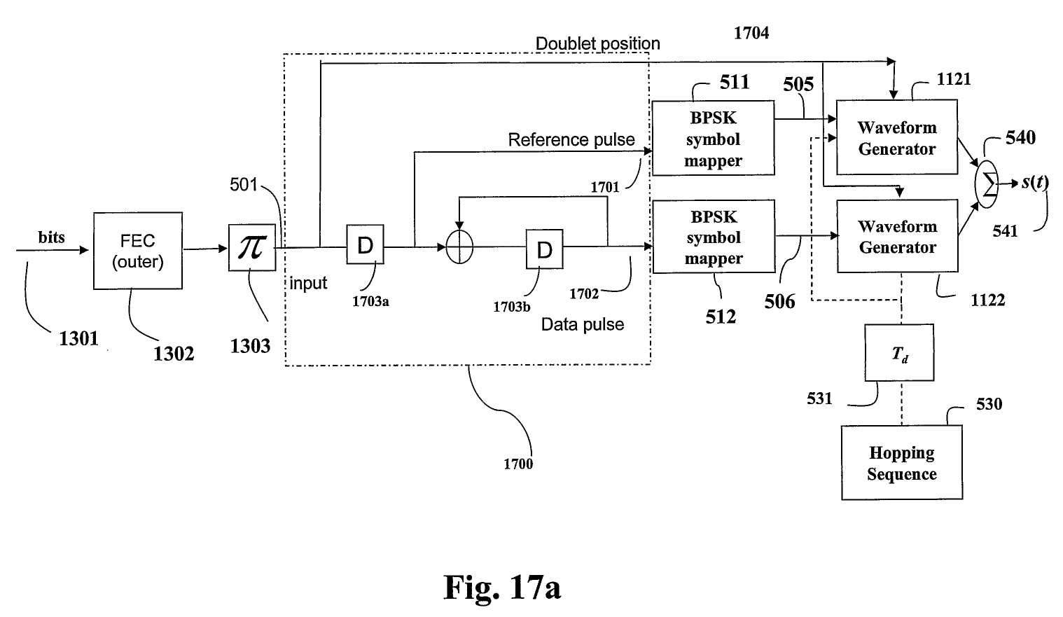

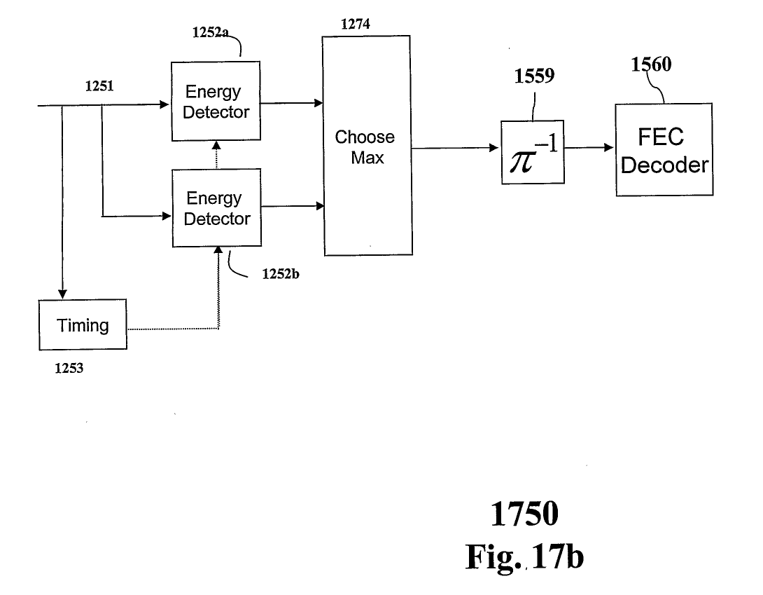

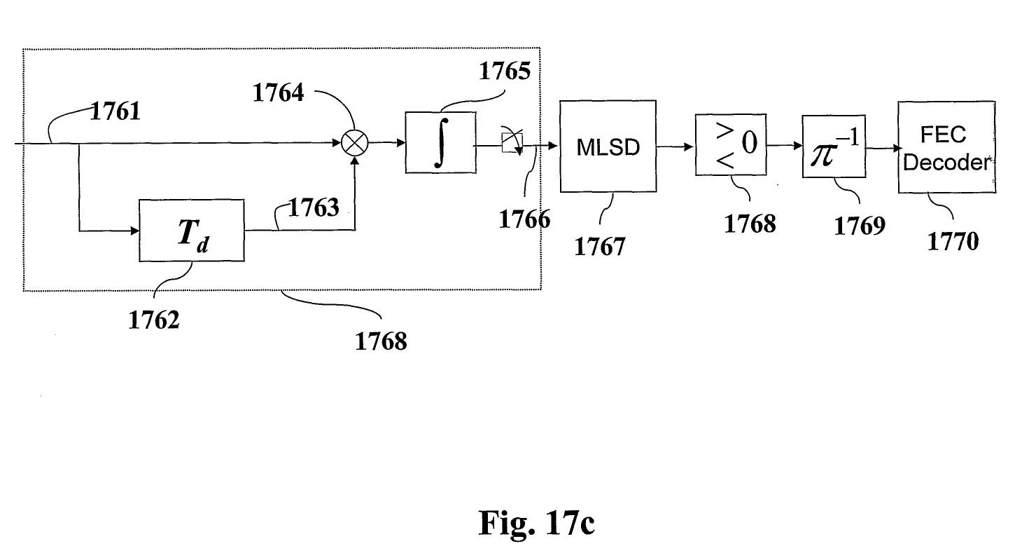

FIGS. 17 and 17a show the transformation more clearly. In this case, processing unit 1700 includes a recursive systematic encoder similar to encoder 1500 of FIG. 15. However, processing unit 1700 also includes two delay elements, 1703a and 1703b, the output of the first delay element 1703a is encoded as was done in FIG. 15. The current bit (no delay added) 1704 is used to modulate directly the positions of the pulse doublets so as to enable a non-coherent detector. The output 1705 of the second delay element 1703b is fedback to the adder 1709. This makes the encoding recursive. FIG. 17a is similar to FIG. 17. However, the input bits 1301 is first fed to the outer FEC 1302 and interleaver 1303. This transmitter structure enables the three receiver types depicted in FIG. 4a (non-coherent, differentially coherent and coherent).

The non coherent detector corresponding to the transmitter of FIG. 17a needs only to detect energy positions in order to recover the current bit from the received waveform. This receiver is shown in FIG. 17b and corresponds to the receiver of FIG. 12a, where the output of decision device 1274 is fed to FEC decoder 1560 via deinterleaver 1559.

As with the previous examples, the differentially coherent TR receiver and the fully coherent receiver receives a coded modulation with memory and able to make use of the redundant information present in the received waveform. As with previous examples, the memory of the H-IR modulation spans two symbols, so different feedback paths may be designed, which causes different complexity for TR-IR or non-coherent energy receivers.

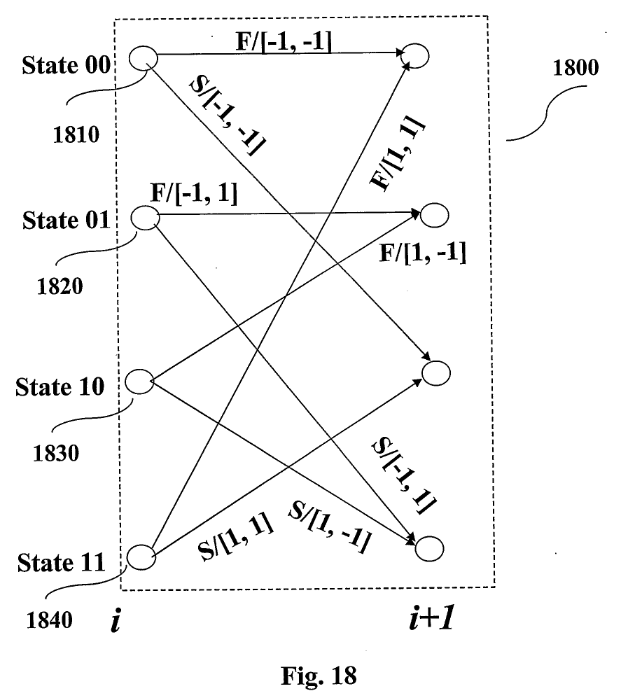

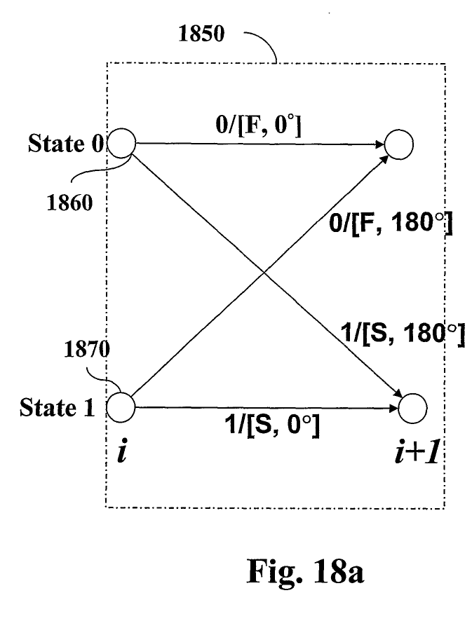

Convolutional encoder 1700 is an encoder that operates in accordance with trellis 1800 shown in FIG. 18. The corresponding coherent receiver for transmitter shown in FIG. 17a is the coherent detector shown in FIG. 14a, albeit with the inner SISO 1401 configured to operate with trellis 1800. Table D lists the eight possible combinations of the current bit and trellis state, the corresponding polarities of the reference and data waveforms, their phase differences, and position of the pulse doublet. The information in Table D corresponds to trellis 1800 shown in FIG. 18, but in this form it is clear that the current bit is easily decoded by detecting energy in either the first half or second half of the received signal.

TABLE D

| | | | | Phase | |
|---|---|---|---|---|---|
| | | | | difference | |
| | | | | between | |
| | | | | reference | Doublet |
| | | | | pulse and | position |
| Trellis | Current | Reference | | modulated | (F: first half, |
| state | bit | pulse | Data pulse | pulse | S: second half) |
| 00 | 0 | −1 | −1 | 0° | F |
| 01 | 0 | −1 | 1 | 180° | F |
| 10 | 0 | 1 | −1 | 180° | F |
| 11 | 0 | 1 | 1 | 0° | F |
| 00 | 1 | −1 | −1 | 0° | S |
| 01 | 1 | −1 | 1 | 180° | S |
| 10 | 1 | 1 | −1 | 180° | S |
| 11 | 1 | 1 | 1 | 0° | S |

In contrast, the TR/differentially coherent receiver corresponding to the transmitter of FIG. 17 is only able to detect the position and the relative phase differences between the reference and data pulses. Therefore, the TR/differentially coherent receiver corresponding to the transmitter of FIG. 17 does not make full use of the absolute phases on the pulses. In this manner, the trellis describing the signal that is seen by the TR receiver is a two state trellis that depends only on the relative difference between the previous two bits seen by the transmitter. The current bit determines the transitions among the two states. Thus, the differentially coherent receiver corresponding to the transmitter of FIG. 17 is the receiver shown in FIG. 15b, albeit where the MLSD 1557 operates with trellis 1850 shown in FIG. 18a.

In trellis 1850 the state ‘0’, 1860, indicates that the previous two bits were either {0,0} or {1,1} while the state ‘1’, 1870, indicates that the previous two bits were either {1,0} or {0,1}. The labels on the trellis branches show the current input to the transmitter and the double positions and the relative phase of the reference pulse and the data pulses.

In summary, with the device of FIG. 17, a sequence of doublets is transmitted according to a time-hopping sequence and, optionally, a polarity hopping sequence. Both sequences are used for transmitter isolation and spectral smoothing of the transmitted signal. Information about the previous bit of an input bit sequence is used to determine the absolute phase of the reference pulse while the current bit is used to determine the relative phase (0°, 180°) of the reference pulse and the data pulse. This allows the concurrent reception/demodulation of the transmitted signal by both coherent and differentially coherent receivers. To enable non-coherent demodulation, the position of the doublets within a signal are also modulated according to the information bits. The current bit being transmitted determines the position of the doublets while the previous two bits determine the absolute phase of the reference pulse and the relative phase between the data and references pulse of the doublets.

### Sixth Embodiment

In the previously described fourth and fifth embodiments, because of the use of recursive modulation, the phase difference in a pulse pair does not depend on the current input bit. Instead, the phase difference in a pulse pair only depends on the state transition. This may give the impression that trellis decoding is needed in the recursive differentially coherent TR receiver. While this is an option described relative to the fourth and fifth embodiments, the increased complexity might be undesirable for simple differentially coherent TR receivers. However, after examining the two state trellises of these embodiments, e.g., trellis 1600 or 1800, it is seen that a simpler symbol by symbol based detection procedure can be implemented that does not require a sequence based detector, i.e., the symbol detection does not require MLSD 1557 shown in FIG. 15b.

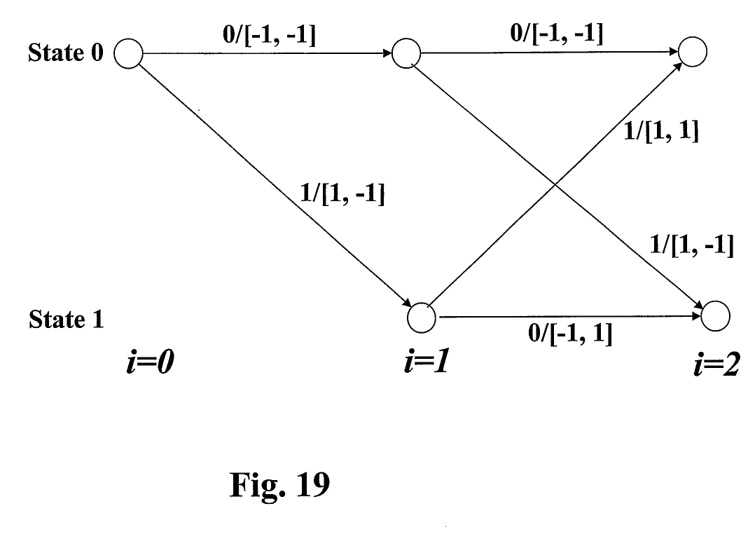

FIG. 19 is a trellis diagram based on trellis 1600 that illustrates the detection procedure of the sixth embodiment. Without loss of generality, one can assume that the trellis 1600 always starts with state ‘0’. At time ‘i=2’, looking at the both branches entering into state ‘0’, the phase difference between pulse pairs are same. That means that the path selection up to time ‘i=1’ solely depends on the phase difference detected at that step. There is the same situation if looking at the branches entering into state ‘1’ at time ‘i=2’. So there is no need for decoding path memory or trace back. As long as the phase difference is known to be 0° or 180° at time ‘i=1’, the transmitted bit can be demodulated as ‘0’ or ‘1’ and the state changes to ‘0’ or ‘1’. After the state at ‘i=1’ is known, then same procedure is applied to demodulate the next bit, and so on. Though the demodulation depends on the trellis state besides the received pulse pair's phase difference, demodulation error does not propagate. Looking the state at time ‘i=1’. No matter which state is decided, a detected phase difference of 180° always leads to a state ‘1’ at time ‘i=2’. Table E shows the combinations.

TABLE E

| | Phase difference | | |
|---|---|---|---|
| | between | | Phase difference |
| | previously | | between currently |
| Trellis state | received pulse pair | Current bit | received pulse pair |
| 0 | 0° | 0 | 0° |
| 0 | 0° | 1 | 180° |
| 1 | 180° | 0 | 180° |
| 1 | 180° | 1 | 0° |

Thus, it is possible to demodulate a signal from the transmitter shown in FIG. 15 with a differentially coherent receiver similar to the receiver shown in FIG. 15b, albeit without MLSD 1557 interposed between the output of correlator 1425 and bit decision device 1428.

### Seventh Embodiment

Sometimes, the differentially coherent TR signaling may not be desired in a system, whereas coherent and non-coherent energy detection in a same system is still desired. In this case, we can select to neglect the phase difference between doublets and only consider modulating information on the position of doublets and the absolution phase of the doubles. In fact, we no longer require a signal consisting of a sequence of doublets and we may consider any sequence on time hopped and (optionally polarity hopped) pulses. As long as we retain the ability to modulate the position and the phase of the pulses, we may enable coherent and non-coherent reception. As multiple pulses are used for each symbol, the entire symbol interval is divided into multiple positions where all pulses are put into one position. Alternatively, the frames in each symbol can be divided into multiple positions, and each pulse is put into a position in the corresponding frame. Therefore, BPPM modulation, in which pulses in the first interval represent 0 and pulses in the second interval represent 1 may be used to modulate data along with the absolute phase of the pulses. Additionally, by using systematic encoding prior to modulation we can enable the concatenated encoding and iterative decoding methods described for the other embodiments.

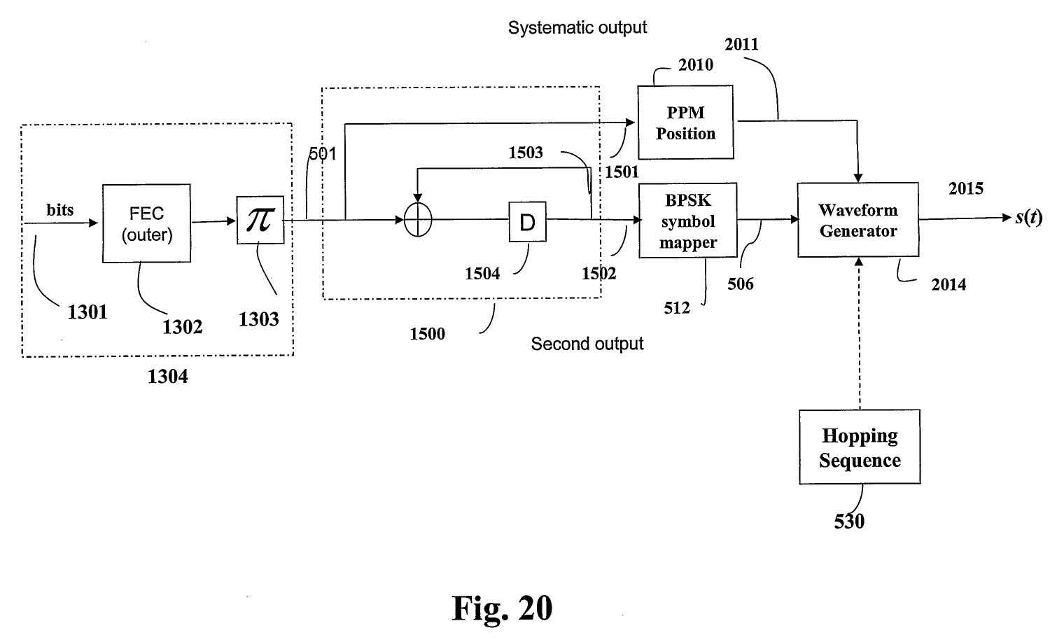

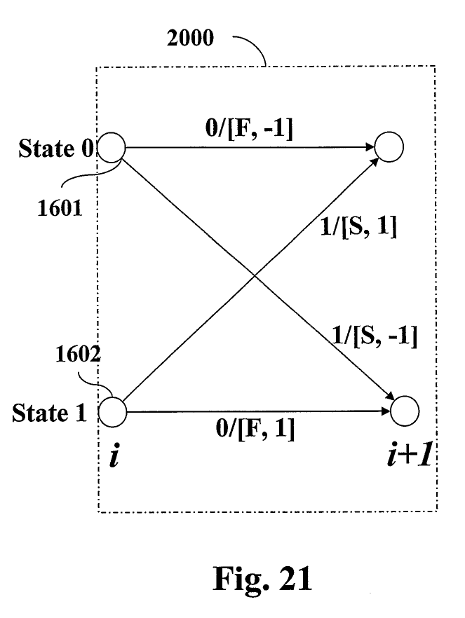

One possible way to achieve this is by modifying the transmitter of FIG. 15 to obtain the transmitter shown in FIG. 20. The hybrid coherent/non-coherent transmitter optionally includes the use of the previously described outer FEC encoder 1304 concatenated with the inner recursive encoder 1500. In this embodiment, the systematic output 1501 is used to encode the pulse position via a pulse position encoder 2010. The recursive output 1502 is used to encode the pulse polarity via the BPSK symbol mapper 512. This results in trellis 2000 shown in FIG. 21. In trellis 2000, the branches are labeled with the value of current bit, and the vector representation of the transmitted pulse's position and polarity. The input and output combination corresponding to encoder 1500 and trellis 2000 is listed in Table F.

TABLE F

| | | Pulse position | |
|---|---|---|---|
| Trellis | Current | (F: first half, | |
| state | bit | S: second half) | Pulse polarity |
| 0 | 0 | F | −1 |
| 0 | 1 | S | −1 |
| 1 | 0 | F | 1 |
| 1 | 1 | S | 1 |

The signal can be decoded by non-coherent energy detectors. That is, the receiver shown in FIG. 17b can be used without modification to demodulate the signal generated by FIG. 20. Meanwhile, the benefits of iterative decoding and MLSD detection can be achieved by coherent receivers with the receiver of FIG. 14a, where the inner SISO decoder uses the trellis 2000 shown in FIG. 21. Other alternative modulation formats with memory can be utilized in the same way here.

One skilled in the art can also envision and implement a transmitter that transmits wave forms that may be concurrently received by differentially coherent and noncoherent receivers in much the same way as described in FIG. 20. In this fashion the systematic output of the inner encoder is used to modulate both the position and the phase of a reference pulse, while the encoded/redundant output of the inner encoder modulates that phase of a data pulse relative the phase of the reference pulse.

### Eighth Embodiment

Different from serial concatenation, parallel concatenation offers another way to get optimal performance with iterative decoding.

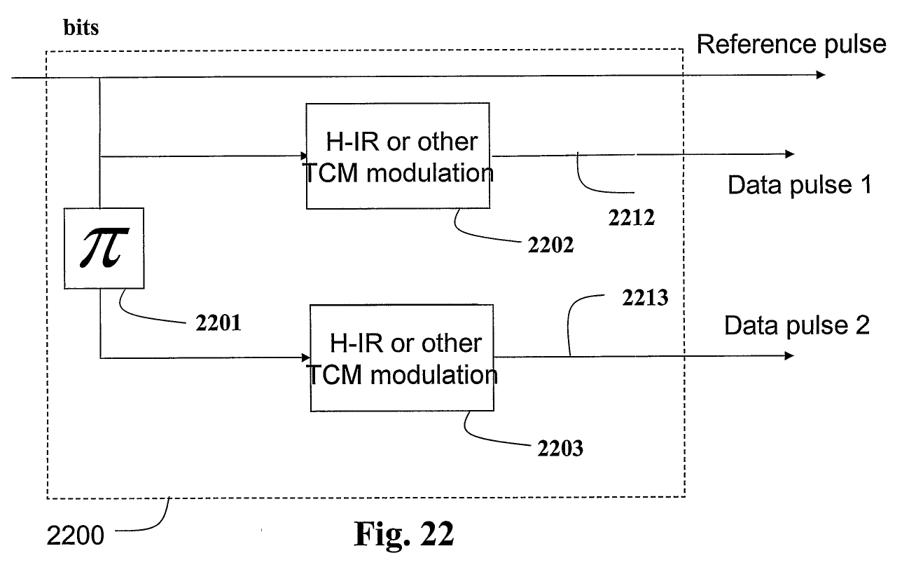

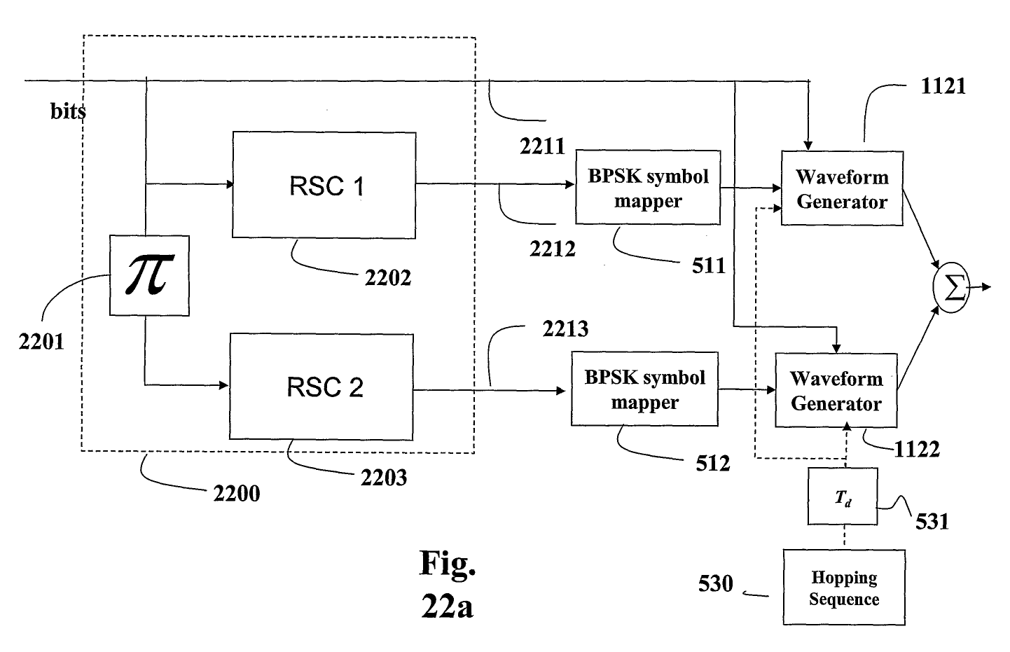

FIG. 22 shows another example structure which is similar to a Turbo code encoder except that the coding steps are incorporated in the modulation stage. Here, the input bits are routed three ways, with one path used for a reference pulse, and two paths directed to parallel modulators 2202 and 2203, albeit with one path of the two paths includes interleaving 2201. When a modulation scheme similar to those produced by preprocessor 510, 1100 or 1500 is used for modulators 2202 and 2203, the modulation output can be viewed as a rate ⅓ convolutional encoder. Here, the bits output from transmitter are incorporated into one symbol: a pulse triplet including one reference pulse and two data pulses, i.e., one data pulse from each of modulators 2202 and 2203. For this embodiment, a differentially coherent TR receiver can still decode by pulse differences with a diversity gain, while a coherent receiver can decode by the trellis 600 or 1600 iteratively as done in Turbo decoder. That is, the transmitter produces a systematic code bit 2211 and two coded bits 2212-2213. The coded bits are used to modulate the absolute phases of the pulses constituting the transmitted waveform. The systematic bit is used to modulate the position of the pulses in the transmitted waveform.

FIG. 22a shows a specific example of the transmitter described in FIG. 22. Here, the preprocessor 1100 of FIG. 11 is replaced with pre-processor 200 of FIG. 22. A receiver of the type shown in FIG. 12a may be used to demodulate and recover the information. Additionally, the coherent receiver shown in FIG. 14a may also be used to demodulate the signal from this transmitter. On the receive side, the inner and outer SISO decoders, 1401-1402, are modified to operate according to the constraints (trellis) of the two RSC encoders, 2202-2203.

### Additional Embodiments

In another view of the H-IR modulation technique described in application Ser. Nos. 10/964,918 and 11/074,168, we can recognize the preprocessing of the bits prior to modulation as a forward error (convolutional) correction code whose outputs are then mapped onto pulse phases and positions. In the third through eighth embodiments, we made use of the fact that the FEC code was systematic so that at least one transmitted waveform parameter (phase, relative phase, position) carried information about unmodified current bit, while the other waveform parameters carried the coded/redundant information about previous bits. At a most general level, the third through eighth embodiments improve the H-IR scheme of the first and second embodiment by concatenating an FEC with the modulator/encoder (as well as with the other techniques previously described). The different outputs of the encoders are modulated onto different waveform parameters (i.e., onto at least two of the following three parameters: phase, relative phase, and position). The third through eighth embodiments can be generalized to encompass any transmitter that transmits a serial or parallel concatenated code where the outputs of the coding stage are mapped onto at least 2 of the following 3 modulation parameters: position; phase difference, and absolute phase. Such a transmitter would be able to transmit a waveform having the property that it may be concurrently received by multiple receiver types.

The first through eighth embodiments are non-limiting examples of advanced ultra-wideband hybrid-IR systems. For example, the above embodiments can be used even if the time hopping sequence has a length one (i.e., only one frame per symbol is being transmitted), and/or if there is only a polarity-hopping sequence, but no time hopping is applied. Furthermore, while BPSK and BPPM modulation types are described, other modulation types may also be adapted to the present invention (e.g., QPSK, QAM, etc.) Also, while many of the preceding examples describe the use of interleavers and FEC encoders, these devices are optional. One skilled in the art will recognize that the ideas embodied in embodiments 1-8 may be further mixed and matched to arrive at additional combinations. Also, the transmitters and receivers described herein may be implemented in hardware, software or a combination thereof. Also, while the principal focus of the preceding discussion relates to ultra-wideband communications, the devices and methods described herein may also be applied to narrowband communications.

1. A transmitter, comprising:
a FEC encoder configured to encode a data stream and having an output;
a modulator having an input connected to the output of the FEC encoder, said input configured to receive a coded input bit sequence, wherein
said modulator is configured to transmit a sequence of doublets according to a time-hopping sequence, wherein information about a previous bit of the coded input bit sequence is modulated as an absolute phase of a reference pulse and information about a current bit is modulated as a relative phase between the reference pulse and a data pulse.

2. The transmitter of claim 1, further comprising:
an interleaver disposed between said FEC encoder and said modulator.

3. The transmitter of claim 1, wherein said modulator comprises:
an input;
a preprocessor connected to said input and having a data output and a reference pulse output;
a first BPSK symbol mapper connected to said data output;
a second BPSK symbol mapper connected to said reference pulse output;
a first waveform generator connected to said first BPSK symbol mapper;
a second waveform generator connected to said second BPSK symbol mapper; and
a summer connected to each of said first and second waveform generators and configured to output a summed waveform.

4. The transmitter of claim 3, wherein said preprocessor comprises:
a non-recursive encoder.

5. A signal embedded in a carrier wave, said signal transmitted by the transmitter of claim 4.

6. A coherent receiver configured to demodulate a signal transmitted by the transmitter of claim 4.

7. A differentially coherent receiver configured to demodulate a signal transmitted by the transmitter of claim 4.

8. The transmitter of claim 3, wherein said preprocessor comprises:
a recursive encoder.

9. A signal embedded in a carrier wave, said signal transmitted by the transmitter of claim 8.

10. A coherent receiver configured to demodulate a signal transmitted by the transmitter of claim 8.

11. A differentially coherent receiver configured to demodulate a signal transmitted by the transmitter of claim 8.

12. The transmitter of claim 3, further comprising:
a bypass line connecting said input to an input to said first BPSK symbol mapper and an input to said second BPSK symbol mapper, wherein
said doublet is part of a triplet of pulses.

13. The transmitter of claim 12, wherein said preprocessor comprises:
a non-recursive encoder.

14. A signal embedded in a carrier wave, said signal transmitted by the transmitter of claim 13.

15. A coherent receiver configured to demodulate a signal transmitted by the transmitter of claim 13.

16. A differentially coherent receiver configured to demodulate a signal transmitted by the transmitter of claim 13.

17. A non-coherent receiver configured to demodulate a signal transmitted by the transmitter of claim 13.

18. The transmitter of claim 12, wherein said preprocessor comprises:
a recursive encoder.

19. A signal embedded in a carrier wave, said signal transmitted by the transmitter of claim 18.

20. A coherent receiver configured to demodulate a signal transmitted by the transmitter of claim 18.

21. A differentially coherent receiver configured to demodulate a signal transmitted by the transmitter of claim 18.

22. A non-coherent receiver configured to demodulate a signal transmitted by the transmitter of claim 18.

23. The transmitter of claim 1, wherein said modulator is further configured to transmit said sequence of doublets according to a polarity-hopping sequence.

24. The transmitter of claim 1, wherein said FEC encoder comprises one of:
a block encoder;
a linear block encoder; and
a convolutional encoder.

25. The transmitter of claim 1, wherein said modulator is one of:
an ultra-wideband modulator;
an impulse modulator; and
a narrowband modulator.

27. A transmitter, comprising:
a FEC encoder configured to encode a data stream and having an output;
a modulator having an input connected the output of the FEC encoder, said input configured to receive a coded input bit sequence, wherein
said modulator is configured to transmit a sequence of doublets including a reference signal and a data signal according to a time-hopping sequence, where information about a current bit is modulated as a position of a doublet and one of
information about a previous bit is modulated as a phase of a reference signal while information about at least two previous bits is modulated as a relative phase between said reference signal and said data signal, and
information about a previous bit and a current bit of said input bit sequence is modulated as a phase of said reference signal.

28. The transmitter of claim 27, wherein said modulator is further configured to transmit said sequence of doublets according to a polarity-hopping sequence.

29. A signal embedded in a carrier wave, said signal transmitted by the transmitter of claim 27.

30. A coherent receiver configured to demodulate a signal transmitted by the transmitter of claim 27.

31. A differentially coherent receiver configured to demodulate a signal transmitted by the transmitter of claim 27.

32. A non-coherent receiver configured to demodulate a signal transmitted by the transmitter of claim 27.

33. A transmitter, comprising:
a parallel concatenated encoder having an input and configured to encode a data stream into a first and second coded pulse sequence, said encoder comprising:
a first RSC encoder directly coupled to said input,
an interleaver directly coupled to said input and having an interleaver output, and
a second RSC encoder connected to said interleaver output; and
a modulator having a first and second modulator input connected to the first and second RSC encoder, respectively, said modulator configured to transmit a sequence of triplets according to a time-hopping sequence, wherein
information about the reference pulse is modulated as a position of the sequence of triplets and information about a current bit is modulated in an absolute phase of the sequence of triplets.

34. The transmitter of claim 33, wherein said modulator comprises:
a first BPSK symbol mapper connected to said first modulator input;
a second BPSK symbol mapper connected to said second modulator input;
a first waveform generator connected to said first BPSK symbol mapper;
a second waveform generator connected to said second BPSK symbol mapper; and
a summer connected to each of said first and second waveform generators and configured to output a summed waveform.

35. A signal embedded in a carrier wave, said signal transmitted by the transmitter of claim 33.

36. A coherent receiver configured to demodulate a signal transmitted by the transmitter of claim 33.

37. A differentially coherent receiver configured to demodulate a signal transmitted by the transmitter of claim 33.

38. A non-coherent receiver configured to demodulate a signal transmitted by the transmitter of claim 33.

39. The transmitter of claim 33, wherein said modulator is further configured to transmit said sequence of triplets according to a polarity-hopping sequence.

40. A transmitter configured to output a waveform, comprising:
an input;
a coding stage connected to said input and having plural coding stage outputs, where the bits of a first coding stage output is mapped onto one parameter of the group of parameters consisting of position, phase difference, and absolute phase, and the bits of a second coding stage output is mapped onto another parameter of said group of parameters;
a modulator having an input connected to the plural coding stage outputs, said modulator configured to transmit a sequence of pulses according to a time-hopping sequence, wherein
said transmitter is configured to transmit one of a serial concatenated code and a parallel concatenated code such that said waveform may be concurrently demodulated by two receivers selected from the group consisting of
a coherent receiver,
a differentially coherent receiver, and
a non-coherent receiver.

41. A signal embedded in a carrier wave, said signal transmitted by the transmitter of claim 40.

42. A coherent receiver configured to demodulate a signal transmitted by the transmitter of claim 40.

43. A differentially coherent receiver configured to demodulate a signal transmitted by the transmitter of claim 40.

44. A non-coherent receiver configured to demodulate a signal transmitted by the transmitter of claim 40.

45. The transmitter of claim 40, wherein said modulator is further configured to transmit said sequence of pulses according to a polarity-hopping sequence.

46. A signal embedded in a carrier wave, said signal transmitted by the transmitter, comprising:
a sequence of pulses modulated according to a time-hopping sequence, wherein information about a previous bit of a coded input bit sequence is modulated as an absolute phase of a reference pulse and information about a current bit is modulated as a relative phase between the reference pulse and a data pulse, and wherein the coded input bit sequence is a FEC coded data stream.
